(19) United States
(12) Patent Application Publication
(10) Pub. No.: US 2021/0241150 A1
(43) Pub. Date: Aug. 5, 2021

(54) Method for Identifying a Valid Energy State

(71) Applicant: Rahko Limited, London (GB)

(72) Inventors: Jules Laurent Guy Tilly, London (GB); Edward Nikolas Grant, London (GB)

(21) Appl. No.: 17/147,879

(22) Filed: Jan. 13, 2021

(30) Foreign Application Priority Data
Jan. 14, 2020 (GB) 2000552.6

(51) Int. Cl. G06N 7/00; G06N 10/00; G06N 20/00; G06F 17/16; G06F 17/18; G06F 1/02

(52) U.S. Cl. CPC G06N 7/00; G06N 10/00; G06F 1/022; G06F 17/16; G06F 17/18; G06N 20/00

(57) ABSTRACT

A method for identifying an excited energy state of a system of interacting electrons, comprising providing a first quantum circuit defined by a generator function and providing a second quantum circuit defined by a discriminator function. The method comprises optimising the values of the set of parameters θ of the generator function to substantially minimise the energy of the state generated by the first quantum circuit, and to substantially minimise the extent of overlap of the state generated by the first quantum circuit and each known valid state of the system. The method further comprises, cooperatively, training the discriminator function by optimising the value of the set of parameters ϕ of the discriminator function, to train the discriminator function to discriminate between the state generated by the first quantum circuit and each of the known valid states of the system. The optimised values of the set of parameters θ of the generator function correspond to values parametrising the generator function for generating the next excited energy state of the system of interacting electrons.

### CROSS REFERENCE TO RELATED CASES

This application claims priority to United Kingdom Application No. 2000552.6, filed Jan. 14, 2020, to Tully, et al., hereby incorporated by reference in its entirety for all purposes.

### FIELD OF THE INVENTION

The present invention relates to a method for identifying a valid excited energy state of a system of interacting electrons. A first excited state and additional excited states may be identified. The method is adapted to make use of a hybrid system of quantum and classical computers.

### BACKGROUND TO THE INVENTION

The interaction of different materials, from drugs molecules to battery cells, depends on the chemical bonds formed between atoms and molecules of matter. Studies of chemical reactions, and our ability to predict the behaviour of the interaction of materials, is currently limited by knowledge of the energy structures of atoms and molecules.

Atoms and molecules may be more prone to certain reactions when in an excited state. An excited state may be generated by promotion of an electron within an atom or molecule from a ground state (or a lower excited state). The electron may be promoted to an excited state by absorption of energy, and energy may be emitted from the atom or molecule when the electron relaxes from the excited state to a ground state (or lower excited state). The energy absorbed to promote an electron to an excited state, or the energy emitted from a molecule upon relaxation of the electron from an excited state, is specific to the type of molecule and its complex electronic structure. As such, an in depth knowledge of the electronic structure of a molecule is essential to our understanding of how materials interact. The electronic structure of materials with more than a few electron are often not well known, however, or easy to predict.

Quantum mechanical models have been developed which describe the theoretical electronic structure of a material. However, for materials with more than a few interacting electrons, computation of such quantum mechanical models is both challenging and computationally intensive. Classical computers are not, at present, capable of solving the complex problems which define molecular energy structures. However, it is anticipated that quantum computers could be used to address specific computational hurdles associated with these calculations. In particular, the complexity of the computation required to compute values related to the energy structure of an atom or molecule tend to scale exponentially with respect to the size of the system studied. As a result, classical computers cannot solve for these values exactly even for systems of limited size.

Quantum computers (or Quantum Processing Units, QPUs) are expected in future to provide exponential increase in the speed of solving several complex computational problems. One example of a computation problem that QPUs could solve is the diagonalisation of large matrices (or, equivalently, the calculation of its eigenvalues and eigenvectors). This type of solution has numerous applications ranging from page ranking for internet search engines to estimation of molecular energy levels.

Algorithms (such as Quantum Phase Estimation, QPE) have been proposed which would provide exponential speed-up of the calculation of eigenvalues for large matrices, when compared to the best-known classical algorithms. However, implementation of this type of algorithm requires advanced QPUs which are unlikely to be available for the next ten years. Therefore, current research has focused on different algorithms, which can make use of present quantum devices such a noisy-intermediate scale quantum devices (NISQ).

Nevertheless, NISQ are prone to errors in quantum calculations. In some cases, methods using NISQ QPUs pair these devices with a classical processing unit (central processing unit, CPU, graphic processing unit, GPU, or field-programmable gate array, FPGA). In these hybrid systems, the operations performed on QPUs can be low depth (in other words, very few quantum gates need to be applied) which limits the risk and impact of errors. Classical processing units can then be used to create feedback loops in the quantum protocol. These types of algorithm promise to be the first commercial applications of quantum computing, as they leverage the benefits of NISQ QPUs, even if prone to errors, whilst making use of the benefits (and previous knowledge and experience) of classical processors.

There have been several algorithms proposed for eigenvalue calculations on a hybrid quantum and classical system, which a focus on Hermitian matrices which can represent the energy profile of a molecule (the Hamiltonian of the molecule). The Variational Quantum Eigensolver (VQE) is a hybrid algorithm that uses a low depth parametrised quantum circuit to produce a quantum state (see for instance Peruzzo et al., “A variational eigenvalue solver on a photonic quantum processor”, Nature Communications (2014) vol. 5, 4213). The expectation value of the Hamiltonian of the system then can be calculated with respect to this state, and a classical algorithm can be used to update the circuit parameters to minimise the expectation value of the Hamiltonian with respect to the state produced. The VQE can therefore be used to calculate the lowest eigenvalue of a matrix (or the ground state energy of a molecular Hamiltonian). However, in general VQE is only used to find the lowest and highest eigenvalues of a Hermitian matrix, rather than any first or further excited state.

In order to find other eigenstates (representing excited states of a molecular system), other methods have been proposed. In some examples (such as McClean et al., “Hybrid quantum-classical hierarchy for mitigation of decoherence and determination of excited states”, Phys. Rev. A (2017) vol. 95, 042308 and Santagati et al. “Witnessing eigenstates for quantum simulation of Hamiltonian spectra”, Science Advances, 26 Jan. 2018: Vol. 4, no. 1, eaap9646), the identification of excited states requires a large number of quantum gates (in other words, a large depth of qubit system), or require a large number of measurements to the qubit system. As such, these methods are not particularly appropriate or adaptable to present, noisy qubit systems, such as NISQ.

Other studies have looked to provide a method for use with NISQ. In one study by Higgott et al. (“Variational Quantum Computation of Excited States”, Quantum, (2019) vol. 3, 156) and using VQE, further eigenstates are found by measuring the overlap of one output state with another, with an objective of minimising the overlap between known energy states (for example, the ground state) and the next unknown eigenstate. However, although possible to apply within a NISQ system, this method can still introduce significant error within the measurement of the output states. Another study by Endo et al. (“Variational quantum algorithms for discovering Hamiltonian spectra”, Phys. Rev. A, (2019) vol. 99, 062304) considers the identification of an excited state using imaginary time evolution of a system of qubits. However, this is prone to a high error probability and so again is not especially suitable to present qubit systems, such as NISQ.

Therefore, each of the previously proposed methods have drawbacks, and are not fully appropriate for implementation on present quantum processing units, such as those using NISQ. In particular, existing methods either rely on complex quantum gates (e.g. SWAP gates) or on processes likely to induce significant calculation errors (such as reversing a parametrized quantum circuit).

As such, there is a requirement for a method and computing system which overcomes these problems. For example, there is a need for a method and computing system which lowers, as much as possible, the hardware requirements on the quantum processing qubits (QPUs), in order allow the method to be used with existing quantum computers, or which can be applied as early as possible on future quantum computers.

### SUMMARY OF THE INVENTION

In order to overcome these problems, there is described a method for identifying an excited energy state of a system of interacting electrons. The method provides an iterative approach in order to optimise coupled quantum circuits designed to separately distinguish between, and generate, low-lying excited energy states of a quantum system. Based on the joint requirements that a wavefunction of an excited state must be orthogonal to (in other words, not overlapping with) a wavefunction of a ground state or other excited state of a system, but also minimised in energy, the method comprises optimization of a generator function and a coupled discriminator function, which cooperatively generate a set of parameters representing a wavefunction of the excited state. An optimum of the discriminator can only be reached conditionally on the generator also being at an optimum.

In particular, the generator function is parameterised by a set of parameters having values representing a trial state of the system, and the values are iteratively adjusted until the generator function is optimised to an energetic minima, whilst also meeting the orthogonality criteria.

At the same time, the discriminator function is trained to be able to distinguish a trial state from a ground state (or known lower energy state). As such, the trained discriminator function, which is coupled to the generator function, is used within the optimisation of the generator function in order to ensure the orthogonality requirement of the trial state is met. Training of the discriminator function takes place by iterative adjustment of the value of parameters parametrising the discriminator function, until the discriminator function can reliably provide a measure of the distinguishability of a trial state compared to a ground state.

Beneficially, the generator and discriminator function may be applied to a system of qubits (within a quantum computing system). However, upon receipt of the output of the generator and discriminator function, the iterative adjustment of the parameters of the generator and discriminator function (to optimise the functions) may take place on a classical computer processor. As a consequence, when implementing the method quantum gates applied to the system of qubits may be shallow (in other words, not require a large number of gate transformations), which can prevent the propagation of errors that are inevitably introduced in deeper systems of presently-available qubits (such as NISQ). Accordingly, the present method solves a number of the problems associated with implementing quantum computational methods on presently available systems of qubits, whilst also harnessing the benefits of quantum processing unit.

As an overview, the method proceeds as follows: a quantum machine learning network known as a discriminator network (or function) is trained to distinguish between a ground state and a generated (or trial) state of the system. The generated (or trial) state is created by another quantum machine learning network known as a generator network (or function), which is trained to help the discriminator find a system state that is as different as possible (in other words, orthogonal to) to the ground state. At the same time the generator is also trained conditionally to minimise the energy of the system in the generated (or trial) state. As a result, the whole network finds a valid state of the system that is different (in particular, orthogonal) to the ground state, and which at the same time minimises the energy: this state is the first excited state. This process can then be repeated, in order to find further excited energy states for the system, each of which must be different (orthogonal) to the ground state and any lower excited state.

In a first aspect there is described a method for identifying an excited energy state of a system of interacting electrons, comprising:

providing a first quantum circuit, the first quantum circuit defined by a generator function parameterised by a set of parameters, θ, wherein applying the first quantum circuit to a set of qubits in an initial state generates a state of the system represented by a wavefunction, ψ;

providing n sets of values θₙ₋₁ for the set of parameters, θ, wherein each set of values θₙ₋₁ generates an nth valid energy state of the system represented by a wavefunction, ψₙ₋₁, wherein n is one or more;

providing a second quantum circuit, the second quantum circuit defined by a discriminator function parameterised by a set of parameters, ϕ, wherein applying the second quantum circuit to the set of qubits in the state of the system represented by the wavefunction, ψ provides an output representing an extent of overlap of the wavefunction ψ with the wavefunction ψₙ₋₁ of each of the n known valid states of the system;

optimising the values of the set of parameters θ to substantially minimise the energy of the state generated by the first quantum circuit represented by the wavefunction ψ, and to substantially minimise the extent of overlap of the state generated by the first quantum circuit represented by the wavefunction ψ and each of the n known valid states of the system represented by respective wavefunction ψₙ₋₁; and

cooperatively, training the discriminator function by optimising the value of the set of parameters ϕ to train the discriminator function to discriminate between the wavefunction ψ of the state generated by the first quantum circuit and the wavefunction ψₙ₋₁ representing each of the n valid states of the system;

wherein the optimised values of the set of parameters θ correspond to a set of values θₙ parametrising the generator function defining the first quantum circuit for generating an n+1th valid energy state of the system represented by wavefunction, ψₙ, which is an excited energy state of the system of interacting electrons.

A system of interacting electrons may be a molecule (or molecular system) or may be a solid (say, on a lattice, for example the Hubbard model). The method may be applied to any system of weakly or strongly interacting electrons (more specifically, any system encoded on a Hermitian matrix).

The wavefunction of the ground state ψ₀ or a first ψ₁ or any further excited state ψₙ, is the quantum mechanical representation of the wave-like characteristics of the system. In particular, the wavefunction provides a mathematical description of a system state. The wavefunction itself represents a probability amplitude, wherein the probabilities for possible results of measurements made to a system can be derived from it. The measured value of the wavefunction does not, in isolation, provide any information about the magnitude or direction of measurable observables; instead, quantum operators can be applied, whose eigenvalues correspond to sets of possible results of measurements to the wave function, ψ. For instance, application of the energy operator (or Hamiltonian operator, Ĥ) to the time-dependent wavefunction ψ(r,t) yields eigenstates from which the energy of a stationary state can be obtained by calculation of an associated eigenvalue.

Valid energy eigenstates of a system (each represented by a wavefunction ψ and derived from application of the system Hamiltonian operator, Ĥ, to the wavefunction ψ(r,t)) are each orthogonal in Hilbert space. This means, in Dirac notation, that [symbol] ψₙ|ψₘ [symbol] =0 if ψₙ and ψₘ correspond to different eigenvalues. States that are not orthogonal may be considered to overlap (in other words, [symbol] ψₙ|ψₘ [symbol] ≠0), and cannot both be valid energy states of the system. Making use of this requirement, in the present method an identified first excited state (represented by wavefunction ψ₁) must be orthogonal to a ground state (represented by wavefunction ψ₀) of the system.

In particular, this constraint is used as an objective to the optimisation of the generator function (to generate, or identify, an excited state orthogonal to a lower valid energy state), and as an objective to the optimisation of the discriminator function (to discriminate between a ground state and an excited state). This is discussed in more detail below.

Moreover, any valid energy state of the system (be it the ground state, a first excited state or further excited state) will necessarily be at the lowest possible energy that also allows it to meet the orthogonality criteria. Therefore, minimisation of the energy for the generated state is a further objective for optimisation (again, this is discussed further below).

The present method (in part) is applied to a set of qubits as part of a quantum computer (or quantum computing device, or quantum processing unit). In quantum computing, a qubit is the basic unit of quantum information, and analogous to the classical binary bit used in classical computing. When measured, a qubit will be in one of two states. However, before measurement, quantum mechanics allows the qubit to be in a coherent superposition of both states/levels simultaneously, a property which is fundamental to quantum mechanics and quantum computing. A system of qubits, which exhibit quantum entanglement, can therefore be in a coherent superposition of a large number of alternative states simultaneously. As a result larger systems can be simulated, much more efficiently using a quantum computer.

In the present method, a set of qubits are placed in a predefined, known initial state, |0 [symbol] ^{⊗d} of dimension d. The set of qubits can then be placed in a new state by application of a series of operations or manipulations to the qubits. This can be considered the equivalent of applying a series of logic gates (for instance, AND or NOT gates) in a classical electrical circuit. As such, the operations are considered a series of ‘quantum gates’ in a ‘quantum circuit’ or ‘quantum network’.

In the present method, the series of gates applied within a quantum circuit is characterised or defined by a generator function, G(θ), or by a discriminator function, D(ϕ) where each the functions are parametrised by a set of parameters θ and ϕ, respectively. In particular, application of a set of quantum gates defined by the generator function G(θ₀) causes a set of qubits in a predefined initial state to be transformed to be in a ground state of the system, and application of a set of quantum gates defined by the generator function G(θ₁) causes the set of qubits in the same initial state to be transformed to be in a first excited state of the system. In the same way, in the present method application of a set of quantum gates defined by the generator function G(θ_{T}) can be considered to cause the set of qubits in the initial state to be transformed to be in a trial state. The trial state can then be ‘tested’ to identify if it meets the orthogonality and energy minimisation criteria which identify the trial state as a valid excited state.

The discriminator function (or discriminator) of the presently described method provides a measure of how different, or distinguishable, is the trial state compared to the ground state. In particular, the discriminator is trained to map the ground state to a given measurement outcome, and the generated state to another measurement outcome which is orthogonal (in Hilbert space) to the ground state. Rather than directly minimising overlap, the optimisation of the discriminator provides a platform for the generator to find a subspace in which the overlap of the generated or trial state and ground state is maximised. In other words, optimisation of the discriminator maximises the likelihood of the discriminator to map the generated state to a measurement outcome orthogonal to the measurement outcome resulting from the ground state being passed through the generator. Thus, the output of the discriminator is not, in itself, the overlap of the wavefunctions representing the ground and the trial states, but is representative of their difference or similarity, and so proportional (or representative) of the extent of the overlap.

For the purposes of distinguishing the trial state from the ground state, the output of the discriminator should be optimised towards a number representing that the trial state and ground state are as different as possible. In this respect, the discriminator function would be considered optimised only in the event that the output to the discriminator function is within an interval of values representing a predefined similarity threshold, Tₛ. In one example where the method looks to identify the n+1th valid energy state of the system, the similarity threshold, Tₛ, will be an interval f values close to (and including) −n+1. For instance, with respect to the first excited state, the similarity threshold, Tₛ, may be an interval of values −0.999 to −1 (inclusive). However, the specific values for the predefined similarity threshold, Tₛ, will be dependent on the particular conventions used for mapping the nth valid energy state and the n+1th valid energy state (see the ‘Mathematical Annex’ below, for more detail).

It is noted that the discriminator function is applied to the set of qubits and an ancilla qubit. The ancilla qubit is an additional qubit, in a known initial state, which is added to the set of qubits when the discriminator function is applied. As quantum systems (and in particular, systems of qubits), exhibit quantum entanglement, measurement of the entangled ancilla qubit can be used to indicate the state of the set of qubits, by providing knowledge of the change to the state of the ancilla qubit after application of a specific set of operations defined by the discriminator. The ancilla qubit is a concept known in the art (see, for instance, https://en.wikipedia.org/wiki/Ancilla_bit retrieved 13 Jan. 2020).

The method may further comprise determining an energy of the n+1th valid energy state of the system represented by wavefunction, ψₙ, parametrised by set of parameters with set of values θₙ. In particular, where n=1 and so the n+1th valid energy state of the system is the first excited state, the expectation value of the wavefunction ψ₁ of the first excited state of the system can be calculated. Advantageously, knowledge of the energy of a valid state (in other words, an excited state) of the system may provide information on the electronic structure of the system, which could be used to predict interactions of materials.

The discriminator and generator functions may be considered as coupled. In particular, the discriminator and generator functions are jointly optimised, wherein the output to the discriminator function, as well as the output to the generator function, may be used to adjust the parameters for the generator function, θ_{T}.

Preferably, the system of interacting electrons corresponds to a molecular Hamiltonian H, having dimensions d×d, and the set of qubits comprises dqubits.

Preferably, prior to providing n sets of values θₙ₋₁ for the set of parameters θ, the method further comprises applying a variational quantum eigensolver to identify the set of values, θ₀, parametrising the ground energy state of the system which is a first valid energy state of the system and represented by a wavefunction, ψ₀. A variational quantum eigensolver is a known technique which applies classical optimisation to minimise the energy expectation value of a trial (or ansatz) to find the ground state (or a valid state) of a molecule. A more detailed description of the variational quantum eigensolver can be found at Peruzzo et al., Nature Communications (2014) vol. 5, 4213. Applying a variational quantum eigensolver may comprise minimising [symbol] 0|G⁵⁵⁴(θ)ĤG(θ)|0 [symbol] .

Preferably, the generator function defines a quantum circuit comprising a pre-defined number of layers, each layer comprising a Rₓ gate, a R_{y} gate, and a CZ gate, to be applied to a set of qubits in an initial state of dimension, d. Preferably, the discriminator function defines a quantum circuit comprising a predefined number of layers, each layer comprising a Rₓ gate, a R_{y} gate, and a CZ gate, to be applied to a set of qubits in an initial state of dimension, d. However, other quantum circuits could be used for the generator and/or the discriminator to achieve the parametrisation of the system wavefunction.

In other words, the quantum circuit defined by the generator function or discriminator function is a computation having a sequence of gates, which are reversible transformations on a quantum mechanical analogue of a d-bit classical register, which are the building blocks of quantum circuits, like classical logic gates with respect to conventional digital circuits.

An Rₓ gate is a rotation operator that may be considered to represent a single qubit rotation through an angle θ (radians) around the x-axis of the Bloch sphere. The Rₓ gate is the quantum equivalent of the NOT gate for classical computers (with respect to the standard basis, |0 [symbol] and |1 [symbol] , in the sense that a measurement of the eigenvalue +1 corresponds to classical 1 or ‘true’ measurement, and measurement of the eignenvalue −1 corresponds to a 0 or ‘false’ measurement). The Rₓ gate maps |0 [symbol] to |1 [symbol] and |1 [symbol] to |0 [symbol] . The Rₓ gate may be defined as:

$${R}_{x} ( θ ) = ( \begin{matrix}cos ( \frac{θ}{2} ) & - i sin ( \frac{θ}{2} ) \\ - i sin ( \frac{θ}{2} ) & cos ( \frac{θ}{2} )\end{matrix} )$$

Similarly, an R_{y} gate is a rotation operator that may be considered to represent a single qubit rotation through an angle θ (radians) around the y-axis of the Bloch sphere. The R_{y} gate may be defined as:

$${R}_{y} ( θ ) = ( \begin{matrix}cos ( \frac{θ}{2} ) & - sin ( \frac{θ}{2} ) \\ sin ( \frac{θ}{2} ) & cos ( \frac{θ}{2} )\end{matrix} )$$

The CZ gate (or CPhase gate) is a two qubit operation, where one or more qubits act as a control for some operation. The CZ gate may be defined as:

$$C Z = ( \begin{matrix}1 & 0 & 0 & 0 \\ 0 & 1 & 0 & 0 \\ 0 & 0 & 1 & 0 \\ 0 & 0 & 0 & - 1\end{matrix} )$$

Alternatively, a CNOT gate could be used in place of a CZ gate.

Preferably, optimising the value of the set of parameters θ comprises:

generating a trial energy state of the system represented by a wavefunction ψ_{T} by applying, to the set of qubits in an initial state, the first quantum circuit defined by the generator function with the set of parameters θ having trial values θ_{T};

determining an output β_{T} to the second quantum circuit by applying, to the set of qubits in the state generated by the first quantum circuit defined by the generator function with the set of parameters having trial values θ_{T} and to an ancilla qubit, the second quantum circuit, and then measuring the ancilla qubit, wherein the second quantum circuit is defined by the discriminator function with the set of parameters ϕ having a set of trial values ϕ_{T};

calculating an energy E_{T} of the trial energy state of the system represented by the wavefunction ψ_{T};

comparing the output R_{T} of the second quantum circuit to a predefined distinctiveness threshold, T_{d};

wherein if the output β_{T} to the second quantum circuit is not within a predefined interval of values representing the distinctiveness threshold, T_{d}; and/or

if the energy E_{T} of the trial energy state of the system represented by the wavefunction ψ_{T} is not substantially at a minima;

then varying the set of trial values θ_{T} and repeating the generating, determining, calculating and comparing steps;

or, if the output β_{T} to the second quantum circuit is within the predefined interval of values representing the distinctiveness threshold, T_{d}; and

if the energy E_{T} of the trial energy state of the system represented by the wavefunction ψ_{T} is substantially at a minima;

then identifying the set of values θ_{T} as the set of values θₙ parametrising the generator function defining the first quantum circuit for generating the n+1th valid energy state of the system represented by wavefunction, ψₙ, which is the identified excited energy state of the system of interacting electrons.

In other words, the parameters θ_{T}of the generator function may be varied based on the energy of the trial state, and whether the energy of the trial state is minimised (defined by the set of convergence criteria). The parameters θ_{T}of the generator function may further be adjusted based on the overlap of the trial state wavefunction ψ_{T} with the ground state wavefunction ψ₀ (or how different, or orthogonal, the trial state wavefunction ψ_{T} is compared to the ground state wavefunction ψ₀). If either the energy, E_{T}, of the trial state is not minimised, or if the trial state wavefunction is not different enough to the ground state wavefunction (which is determined by whether the output of the discriminator is within a user-defined interval of values representing a predefined distinctiveness threshold, T_{d}), then the generator function is not optimised, and the parameters θ_{T}of the generator function should be further adjusted.

In relation to the predefined distinctiveness threshold, T_{d} for the purposes of distinguishing the trial state from the ground state, the output of the discriminator should be optimised to be within an interval of values defined as the distinctiveness threshold, T_{d}. Meeting this objective represents the trial state being as different as possible compared to the ground state.

Preferably, the generating and determining steps take place at a quantum computer, and the calculating, comparing, varying and identifying steps take place at a classical computer. In particular, a set of qubits (as part of a quantum computer) is used to provide the output to the generator and discriminator functions, in order to find the energy of the trial state of the system, E_{T}, and a value representative of the extent of the overlap of the wavefunction of the trial state of the system with the wavefunction of the ground state of the system. However, the decision steps to determine if the generator function has been optimised, and if not, then the adjustment of the parameters θ_{T} of the generator function may take place on a classical computer. Beneficially, the described method therefore takes advantage of the shallow quantum circuit represented by the generator and discriminator functions, and uses a hybrid system of quantum computer processing units and classical computer processing units to counteract the errors that can propagate in systems of the type of qubits presently available (NISQ qubits).

Optionally, the set of qubits are a Noisy Intermediate-Scale Quantum (NISQ) qubit system. In particular, the power of quantum computers is in the theoretical ability to solve algorithms (such as Shor's algorithm for factorisation) which are unfeasible on classical computers. However, such quantum computers will require a large number (10⁶ or more) qubits. Many of these qubits will be required for the purposes of error correction to provide fault-tolerant quantum computers, with most proposed quantum algorithms being very sensitive to noise. Present quantum computers cannot provide such large systems of qubits. However, systems have been developed in which ten or more of qubits can be provided (an ‘intermediate scale’ system). This allows simpler quantum algorithms to be implemented which are still beyond the reach of classical computers, but will not provide sufficient qubits for error correction. As a result, to make use of these intermediate scale imperfect, noisy qubit systems, new methods or algorithms must be formulated. The present invention is once such method, and may be advantageously applied to a NISQ qubit system because the shallow quantum circuit represented by the described generator and discriminator functions may be less affected by the errors (or noise) innate to NISQ qubit systems.

Preferably, calculating an energy E_{T} of the trial energy state of the system represented by the wavefunction ψ_{T} comprises:

determining the positive-operator valued measurement of the wavefunction ψ_{T}. The positive-operator valued measurement of a wavefunction is a technique known to the person skilled in the art, and for instance is discussed at https://en.wikipedia.org/wiki/POVM (retrieved 13 Jan. 2020).

Calculating the energy of the output of the generator function (the generated or trial state) may comprise obtaining, through a repeated process, the expectation value of the trial state wavefunction ψ_{T} when an energy operator is applied. In other words, calculating the energy of the trial state may comprises obtaining the expectation value (or energy) E_{T}= [symbol] ψ_{T}|\hat{H}|ψ_{T} [symbol] , where Ĥ is the Hamiltonian of the system of interacting electrons, of dimension d×d.

Preferably, measuring the ancilla qubit to determine the output β_{T} to the second quantum circuit comprises:

determining an expectation value of a positive-operator valued measurement of the state of the set of qubits and the ancilla qubit after application of the second quantum circuit. The expectation value is the expected value of a measurement of the ancilla qubit after application of the discriminator function. The expectation value can be considered as an average of all the possible outcomes of a measurement as weighted by their likelihood. It is a fundamental concept in all areas of quantum physics, and for instance is discussed at https://en.wikipedia.org/wiki/Expectation_value_(quantum_mechanics) (retrieved 13 Jan. 2020).

Preferably, the ancilla qubit is prepared in a pre-defined initial state, |0 [symbol] , before application of the second quantum circuit. The initial state is a known state, such that, upon measurement of the ancilla qubit after application of the discriminator function, the change in the ancilla qubit can be identified (and thus the effect of the discriminator function understood).

Preferably, the parameters θ_{T}are varied based on the output of a cost function parameterised by the energy E_{T} of the trial energy state of the system represented by the wavefunction ψ_{T} and the output β_{T} to the second quantum circuit. Preferably, the parameters θ_{T}are adjusted by minimisation of the output to the cost function. The cost function is designed to achieve the specific objective required (for instance, minimisation of the energy of the trial state, and orthogonality of the ground state and the trial state). The optimisation or minimisation of the cost function may take place on a classical computer.

Optionally, the output of the cost function may be minimised using a gradient method or a gradient-free optimiser (for example the RotoSolver algorithm or the RotoSelect algorithm). Other methods of optimisation may be used, for example iterative methods such as Newton-Raphson. Suitable cost functions and their use for minimisation of the values of set of parameters θ_{T} will be known to the skilled person. For instance, the cost function may be optimised with the objective of obtaining a set of values for parameters θ_{T} which will reduce the energy of the trial state and/or increase the orthogonality of the trial state. In one example, the Rotosolver algorithm sequentially adjusts angles of rotation and circuit structure in order to efficiently minimize the energy in a variational problem.

Preferably, training the discriminator function by optimising the value of the set of parameters ϕ comprises:

generating an nth valid energy state of the system represented by the wavefunction, ψₙ₋₁ by applying, to a set of qubits in an initial state, the first quantum circuit defined by the generator function with the set of parameters having values θₙ₋₁;

determining an output β_{V} to the second quantum circuit by applying, to the set of qubits in the state generated by the first quantum circuit defined by the generator function with the set of parameters having values θₙ₋₁ and to an ancilla qubit, the second quantum circuit, and then measuring the ancilla qubit, wherein the second quantum circuit is defined by the discriminator function with the set of parameters ϕ having a set of trial values ϕ_{T};

comparing the output β_{V} of the second quantum circuit to a predefined similarity threshold, T_{d};

wherein if the output β_{V} of the second quantum circuit is not within a predefined interval of values representing a predefined similarity threshold, Tₛ;

then varying the set of trial values ϕ_{T} and repeating the generating, determining and comparing steps.

In this case, the discriminator is trained by application to a generated state that is a known valid energy state: the ground state. As noted above the output of the discriminator is trained to distinguish a known, valid state from another state. The output of the discriminator is representative of, or proportional to, the overlap of an input state with a known state. Accordingly, in this portion of the described method the output of the discriminator effectively is a measure of the overlap of a known valid energy state wavefunction with itself, which, if the discriminator is optimised should yield a result indicative of the wavefunctions being entirely overlapping (or indistinguishable). Therefore, here the output of the discriminator should be optimised to recognise the input function is the same as the ground function. In practice, the discriminator function would be considered trained in this respect if the output to the discriminator is within a predefined interval of values representing a similarity threshold, Tₛ. If the output of the discriminator is outside of this threshold interval, then the values ϕ_{T} which parametrise the discriminator need further optimisation, and so the parameters ϕ_{T} should be further adjusted.

Preferably, the generating and determining steps take place at a quantum computer, and the comparing and varying steps take place at a classical computer. In other words, the logic to determine if the discriminator has been optimised may be applied at a classical computer, after receiving the output to the discriminator obtained via a quantum computer. Furthermore, the classical computer may adjust the parameters ϕ_{T} to obtain the new set of parameters to be provided to the quantum computer to be used in the application of the next iteration of the discriminator function.

Preferably, measuring the ancilla qubit to determine the output β_{V} to the second quantum circuit, comprises:

determining an expectation value of a positive-operator valued measurement of the state of the set of qubits and the ancilla qubit after application of the second quantum circuit.

Preferably, prior to the application of the second quantum circuit, the ancilla qubit is prepared in a pre-defined initial state, |0 [symbol] .

Preferably, the parameters ϕ_{T} are varied based on the output of a cost function parameterised by the output to the second quantum circuit, β_{V}. Optionally, the parameters ϕ_{T}are adjusted by minimisation of the output to the cost function. Optionally, the output may be minimised using a gradient method or a gradient-free method such as the RotoSolver algorithm, although any suitable optimisation method could be used.

Preferably, prior to providing n sets of values θₙ₋₁ for the set of parameters θ, the method further comprises applying a variational quantum eigensolver to identify the set of values, θ₀, parametrising the ground energy state of the system which is a first valid energy state of the system and represented by a wavefunction, ψ₀.

Preferably, prior to optimising the values of the set of parameters θ and prior to training the discriminator function by optimising the value of the set of parameters ϕ, the method further comprises generating an initial set of randomised parameters, θ_{T} and an initial set of randomised parameters, ϕ_{T}. In each case, the randomised parameters may be any set of parameters, and may be considered a starting point for the optimisation of the generator function and the discriminator function. The initial set of randomised parameters, θ_{T} may be the same as the ground state parameters, θ₀, although this is not required. However, it has been found by the present inventors that setting the initial set of randomised parameters, θ_{T} the same as the ground state parameters, θ₀ may be more computationally efficient and arrive at a valid excited state of the system more quickly.

Preferably, optimising the value of the set of parameters θ cooperatively with training the discriminator function by optimising the set of values ϕ comprises: optimising the value of the set of parameters θ whilst optimising the set of values ϕ, such that the set of trial values ϕ_{T} at a given time are used for optimising the value of the set of parameters eat that time. In other words, during the optimisation and training steps, the present, or most up-to-date value of θ_{T} and ϕ_{T} may be ‘fed-back’ to be used within the next iteration of the optimisation of the generator and training of the discriminator function.

For each repetition or iteration for the optimisation of the generator or the training of the discriminator, either the parameters θ_{T}of the generator function or the parameters ϕ_{T} of the discriminator function are adjusted. The parameters θ_{T} of the generator function or the parameters ϕ_{T} of the discriminator function are adjusted dependent on the output to three different calculations, as discussed below. For identification of a first excited state, the portion of the method for adjustment of the parameters θ_{T} of the generator function or for adjustment of the parameters ϕ_{T} of the discriminator function may be selected randomly and equiprobably in each iteration of the optimisation.

It will be understood that in relation to the similarity threshold, Tₛ, and the distinctiveness threshold, T_{d}, both thresholds represent a set of values having a predefined range. For example, in an ideal system where the trial state is a n+1th valid energy state of the system, the output β_{T} to the second quantum circuit will tend to a ultimate value or criterion. However, in practice a range of values close to this ultimate value of criterion can be considered as meeting a threshold for the output, and so the optimisation objective has been met. In other words, the threshold could be considered as being within a certain percentage (for instance, within 0.1%) of this criterion.

The specific values for the similarity threshold, Tₛ, and the distinctiveness threshold, T_{d,} are related to the mathematical convention chosen for mapping a known valid energy state and the unknown valid energy state that is to be identified. In particular, The discriminator is composed of n+1 (where n valid energy states are known), In the case in which the ground state is used as an input to the discriminator, the ground state can be mapped to one of two basis states, |0 [symbol] or |1 [symbol] . Similarly, the trial state used as input to the discriminator is, at optimum, mapped to the other basis state. Optimisation of the discriminator can only be reached under the condition that the generator is also optimised (and reciprocally, hence we need to optimise them iteratively). The value attached to the measurement of each state can be any number, but by convention, we attach 0 to state |1 [symbol] and 1 to state |0 [symbol] .

When the discriminator quantum circuit is applied the following convention is used: the discriminator applied to the ground state as the trial state is mapped to state |0 [symbol] and the discriminator applied to the ‘real’ trial state is mapped to state |0 [symbol] . Thus, the Discriminator cost function is:

γ[(Output of D(‘real’ trial state)−Output of D(ground state)]

Where γ is a weighting factor required for the global minimum to be the unknown valid state to be identified. γ needs to be at least equal to the energy gap between the ground state and the computed excited state multiplied by the dimension of the system studied.

Hence in an ideal system in which the discriminator is optimised to identify the first excited state, the output to the discriminator when applied to the identified first excited state would be −1.0. Therefore, in this case, the predefined interval of values representing the distinctiveness threshold, T_{d}, would be a set of values close to −1 (for instance, a set of values in the range −0.999 to −1, or 0.99 to −1, or any range suitable for the desired level of precision). The predefined interval of values representing the similarity threshold, Tₛ, would be a set of values close to 0 (for instance, a set of values in the range −0.001 to 0, or -0.01 to 0, or any range suitable for the desired level of precision).

Similarly, if the discriminator is optimised to identify the nth excited state (n+1th valid energy state), the output to the discriminator when applied to the nth excited state would be n. The discriminator cost function in this case would be:

γ[Output of D(n+1th valid energy state)−Output of D(nth valid energy state)−Output of D(n−1th valid energy state) . . . Output of D(1st valid energy state)]

Here, the predefined interval of values representing the distinctiveness threshold, T_{d}, would be a set of values close to −n (for instance, a set of values in the range (n+0.001) to −n, or (−n+0.01) to n, or any range suitable for the desired level of precision). The predefined interval of values representing the similarity threshold, Tₛ, would be a set of values close to 0 (for instance, a set of values in the range −0.001 to 0, or −0.01 to 0).

Nevertheless, it should be understood that the particular values for the similarity threshold T_{d}, and similarity threshold, T_{d}, are therefore a consequence of the mapping conventions applied. Any suitable values consistent with a chosen mapping convention could be used. The range of values representing the thresholds can be chosen to provide a suitable level of precision for the optimisation of the functions, and in order to identify the valid energy state in view of the size of the system.

In a second aspect there is described a computing apparatus for identifying an excited energy state of a system of interacting electrons, comprising:

a classical computer; and

a quantum computer comprising a set of qubits, the quantum computer configured to apply a first quantum circuit the first quantum circuit defined by a generator function parameterised by a set of parameters, θ, wherein applying the first quantum circuit to a set of qubits in an initial state generates a state of the system represented by a wavefunction, ψ, and to apply a second quantum circuit defined by a discriminator function parameterised by a set of parameters, ϕ, wherein applying the second quantum circuit to the set of qubits in a state of the system represented by a wavefunction, ψ provides an output representing an extent of overlap of the wavefunction ψ with the wavefunction ψₙ₋₁ of each of the n known valid states of the system, wherein each of the n known valid states of the system are parametrised by a set of values θₙ₋₁ for the set of parameters, θ;

wherein the computing apparatus is configured to optimise the values of the set of parameters θ to substantially minimise the energy of the state generated by the first quantum circuit represented by the wavefunction ψ, and to substantially minimise the extent of overlap of the state generated by the first quantum circuit represented by the wavefunction ψ and each of the n known valid states of the system represented by respective wavefunction ψₙ₋₁; and

cooperatively, to train the discriminator function by optimising the value of the set of parameters ϕ to train the discriminator function to discriminate between the wavefunction ψ of the state generated by the first quantum circuit and the wavefunction ψₙ₋₁ representing each of the n valid states of the system;

wherein the optimised values of the set of parameters θ correspond to a set of values θₙ parametrising the generator function defining the first quantum circuit for generating an n+1th valid energy state of the system represented by wavefunction, ψₙ, which is an excited energy state of the system of interacting electrons.

The computing apparatus comprises a combination of a quantum computer processor and a classical computer processor. As such, the apparatus is a hybrid computing apparatus. Information is exchanged between the quantum and classical processors, in order to obtain the ultimate output of the apparatus, which may be output to a user via a display or recorder from the classical computer.

The classical computer may be any known classical computer processor (central processing unit (CPU), graphics processing unit (GPU), or field-programmable gate array (FPGA), etc.) suitable or capable of the required function of the invention.

The quantum computer comprises a set of qubits, which may be interacting. The qubits can be set in a predefined initial state, and a quantum circuit can be applied to the set of qubits to transform the qubits into a further state. The set of qubits may include any number of qubits required for a given calculation. In some cases, one or more of the qubits within the quantum computer may be defined as an ancilla qubit, and used for measurement of the state of others of the qubits within the quantum computer. In some cases, the qubits may be of a Noisy Intermediate-Scale Quantum (NISQ) type.

The quantum circuit can be considered a function representing a series of operations to be applied to the qubits, to transform the state of the qubits. The quantum circuit is analogous to the application of AND and NOT operators or logic gates in a classical circuit. The quantum circuit is defined by a function, which is parametrised by a set of parameters. For instance, in the present case a first function, the Generator function G(θ), is parametrised by a set of values θ, and a second function, the Discriminator function D(ϕ), is parametrised by a set of values ϕ.

The generator function G(θ) is a quantum circuit that can generate a known state of a system. For instance a known ground state of the system can be generated by applying generator function G(θ) with a known set of parameters θ₀ to the set of qubits in a predefined initial state. Similarly, a first excited state can be generated by applying generator function G(θ) with a known set of parameters θ₁ to the set of qubits in the same predefined initial state. Thus, knowledge of the set of parameters θₙ allows, via the generator function G(θ), generation of a nth excited state (otherwise considered an n+1th known and valid state of the system).

The discriminator function D(ϕ) is a quantum circuit which provides an output proportional to the orthogonality of a trial state (to which the discriminator function D(ϕ) is applied) and another known, valid energy state (such as the known ground state). The orthogonality can be considered as a measure of the overlap in Hilbert space of the wavefunction of the trial state with the wavefunction of the known state. Accordingly, the output to the discriminator function D(ϕ) describes how different is the wavefunction of the trial state in comparison with the wavefunction of the known state. An output of 1 from the discriminator function D(ϕ) indicates that the wavefunction of the trial state and the wavefunction of the known state are the same, and so are indistinguishable. An output of 0 from the discriminator function D(ϕ) indicates the wavefunction of the trial state and the wavefunction of the known state are entirely different, and so are completely distinguishable.

The described computing apparatus is configured to optimise the generator function G(θ) in order to find a set of parameters θ_{T} that parameterise the generation of a trial state having minimum energy (whilst also meeting the required constraints of the discriminator function D(ϕ)). At the same time, and in cooperation, the computing apparatus is configured to optimise the discriminator function D(ϕ) to identify a trial state that is orthogonal to (or entirely different from) a known, valid state (whilst also meeting the required constraints of the generator function G(θ)). The functions may be considered cooperative, because the optimisation of both functions each feedback into the iteration or optimisation of the other. When a set of parameters θ_{T} is identified which meets both the requirement for orthogonality and the requirement for minimum energy, the set of parameters θ_{T} is identified as representing an n+1th valid excited state of the system. As such, the set of parameters θ_{T} is redefined as parameters θₙ which can be used to generate the n+1th excited state.

As such, the present invention makes use of certain principles of the machine learning technique of generative adversarial networks (GAN). However, in the present case, this technique is adapted, such that the networks are cooperative, rather than adversarial. This innovative adaptation of the known technique is astutely applied to a quantum system, in which the requirement is for identification of an entirely different, rather than entirely similar, trial output to the generative network.

In particular, in a GAN two networks are competing with each other: the generator tries to fool the discriminator that the data it produces is real data. Classically, GANs can be used to create realistic fake images (for example, a fake cat which no one can tell is fake). GAN has previously been applied to a quantum system (for example, in Benedetti et al. “Adversarial quantum circuit learning for pure state approximation”, New J. Phys. (2019) Vol. 21, 043023), in which the quantum-GAN learns how to reproduce an unknown quantum state.

However, the present invention inverts the logic of the GAN, so the two circuits (generator and discriminator) are cooperating rather than competing. As a result, rather than learning how to produce a fake quantum state that can fool the discriminator, the generator in the present method learns to assist the discriminator by producing a state that is as far away as possible (or the opposite) to the reference input (which is a known, valid energy state).

The analogy of the present method is nonsensical—it would take as input an unknown data structure and would learn to produce the opposite of it (for instance, if the unknown data structure was an image of a cat, it would produce the opposite of a cat, which is meaningless). On a quantum machine however, the opposite of a known, valid quantum state is an orthogonal state (wherein two orthogonal states have a minimum overlap of 0 in the Hilbert space).

As such, although some prior art methods (such as Higgott et al. “Variational Quantum Computation of Excited States”, Quantum, (2019) vol. 3, 156) aim at minimisation of the overlap of a known state and a proposed state, the present method uses a completely different method to achieve this. Instead of directly minimising the overlap, two cooperating circuits are used (the generator and the discriminator) which are trained alternatively to find a state as different as possible from the original known state. Although the objective of the present method and that of Higgott et al. may be the same, there is no mathematical equivalence between the methods. The present method provides an alternative which can be more readily applied to present systems of qubits (such as NISQ), and moreover may in some cases be computationally less intensive to apply. Specific benefits include that the described method does not require complex operations (such as the inversion of a quantum circuit, as required by some prior art methods); that the described method is fully variational, and so relies on principles that have been largely tested on actual quantum machines in other contexts; that the described method requires minimal classical computation overhead (which can be easily performed and scaled-up on current hardware); that the described method is resistant to NISQ circuit and read-out errors as the discriminator does not necessarily need to be fully optimised (see mathematical annex); and, that the described method is general and it is not restricted to studying specific types of system.

Optionally, the described computing apparatus is further configured to determine an energy of the excited state parametrised by set of parameters θₙ. In other words, having obtained values θₙ for parameters θ, the n+1th valid excited state can be generated, and the wavefunction, ψₙ, for the n+1th excited state known. From the wavefunction, the energy for the state can be calculated (using known quantum mechanical methods). As such, the energy required to excite an electron of the system of interacting electrons (for instance, an electron in the molecule) from the nth to the n+1th state can be calculated. Knowing this energy assists to characterise chemical reactions of the material defined by the system of interacting electrons, and so how it will interact with its environment. Accordingly, knowledge of this energy of the excited state parametrised by set of parameters θₙ can lead to design of new materials, or modification of known materials.

Preferably, the system of interacting electrons corresponds to a molecular HamiltonianĤ, having dimensions d×d, and the set of qubits comprises dqubits.

Preferably, the classical computer is further configured to applying a variational quantum eigensolver to identify the set of values, θ₀, parametrising the ground energy state of the system which is a first valid energy state of the system and represented by a wavefunction, ψ₀. In particular, applying a variational quantum eigensolver may comprise minimising [symbol] 0|G^{†}(θ)ĤG(θ)|0 [symbol] .

Preferably, the generator function defines a quantum circuit comprising a pre-defined number of layers, each layer comprising a Rₓ gate, a R_{y} gate, and a CZ gate, to be applied to a set of qubits in an initial state of dimension, d.

Preferably, the discriminator function defines a quantum circuit comprising a predefined number of layers, each layer comprising a Rₓ gate, a R_{y} gate, and a CZ gate, to be applied to a set of qubits in an initial state of dimension, d.

Preferably, the computing apparatus being configured to optimise the values of the set of parameters θ to substantially minimise the energy of the state generated by the first quantum circuit represented by the wavefunction ψ, and to substantially minimise the extent of overlap of the state generated by the first quantum circuit represented by the wavefunction ψ and each of the n known valid states of the system represented by respective wavefunction ψₙ₋₁ comprises:

the quantum computer being configured to:

generate a trial energy state of the system represented by a wavefunction ψ_{T} by applying, to the set of qubits in an initial state, the first quantum circuit defined by the generator function with the set of parameters θ having trial values θ_{T};

determine an output β_{T} to the second quantum circuit by applying, to the set of qubits in the state generated by the first quantum circuit defined by the generator function with the set of parameters having trial values θ_{T} and to an ancilla qubit, the second quantum circuit, and then measuring the ancilla qubit, wherein the second quantum circuit is defined by the discriminator function with the set of parameters ϕ having a set of trial values ϕ_{T}; and

the classical computer being configured to:

calculate an energy E_{T} of the trial energy state of the system represented by the wavefunction ψ_{T};

compare the output R_{T} of the second quantum circuit to a predefined distinctiveness threshold, T_{d};

wherein if the output β_{T} to the second quantum circuit is not within a predefined interval of values representing the distinctiveness threshold, T_{d}; and/or

if the energy E_{T} of the trial energy state of the system represented by the wavefunction ψ_{T} is not substantially at a minima;

then vary the set of trial values θ_{T};

or, if the output β_{T} to the second quantum circuit is within the predefined interval of values representing the distinctiveness threshold, T_{d}; and

if the energy E_{T} of the trial energy state of the system represented by the wavefunction ψₜ is substantially at a minima;

then identify the set of values θ_{T} as the set of values θₙ parametrising the generator function defining the first quantum circuit for generating the n+lth valid energy state of the system represented by wavefunction, ψₙ, which is the identified excited energy state of the system of interacting electrons.

As noted above, the optimisation looks to minimise the energy of the trial state. In other words, the values of parameters θₜ are optimised until the energy of a trial state are reduced to a local minima (which may also be a global minima). Techniques for recognition of an energy minima and minimisation will be known to the skilled person.

The optimisation of the values of parameters θ_{T} also looks to reduce or avoid overlap between the trial state and a known, valid energy state. Ideally, the overlap is reduced to zero, in other words, the trial state is identified which is entirely orthogonal to the known, valid state. In practice, the optimisation will be continued until the trial state is ‘orthogonal enough’ compared to the known, valid state. This can be quantified by comparison of the output of the discriminator function to an interval of values representing a distinctiveness threshold, T_{d}. The output of the discriminator function being within this threshold is representative that the trial state is entirely different from the known, valid state.

Application of the generator and discriminator functions take place at the set of qubits (and the ancilla qubit) at the quantum computer. However, the steps required for optimisation of the values of parameters θ_{T} take place at the classical computer. In other words, the steps of computing the energy of the trial state, and the comparison of the energy and the orthogonality measures to determine if the optimisation is complete, take place at the classical processor, and can be led-back' to the quantum processor for use in any further iterations of the optimisation process. Beneficially, this means that each iteration of the optimisation process returns to the classical computer. Thus, the errors inherent in operations using presently available sets of qubits are not propagated through the whole method, but are ‘reset’ for each iteration.

Preferably, for each iteration, the quantum computer processing unit is configured to:

receive a set of parameters θₜ of the generator function and a set parameters ϕ_{T} of the discriminator function from the classical computer processing unit, and;

generate an output from the quantum computer processing unit representative of the state of the set of qubits after application of the quantum circuit defined by the generator function and/or discriminator function;

provide the output to the classical computer processing unit.

Preferably, the classical computer being configured to calculate an energy E_{T} of the trial energy state of the system represented by the wavefunction ψ_{T} comprises the classical computer being configured to:

determine the positive-operator valued measurement of the wavefunction ψ_{T}.

Preferably, the quantum computer being configured to measure the ancilla qubit to determine the output β_{T} to the second quantum circuit comprises the quantum computer configured to:

determine an expectation value of a positive-operator valued measurement of the state of the set of qubits and the ancilla qubit after application of the second quantum circuit.

Preferably, prior to the second quantum circuit being applied, the quantum computer is configured to prepare the ancilla qubit in a pre-defined initial state. The initial state is a known state, such that, upon measurement of the ancilla qubit after application of the discriminator function, the change in the ancilla qubit can be identified (and thus the effect of the discriminator function known).

Preferably, wherein the classical computer being configured to vary the set of trial values θ_{T} comprises the classical computer configured to vary the parameters θ_{T} based on the output of a cost function parameterised by the energy E_{T} of the trial energy state of the system represented by the wavefunction ψ_{T} and the output β_{T} to the second quantum circuit.

Preferably, the parameters θ_{T} are adjusted by minimisation of the output to the cost function. Optionally, the output may be minimised using a gradient method or a gradient-free method such as the RotoSolver algorithm.

Preferably, the computing apparatus configured to train the discriminator function by optimising the value of the set of parameters ϕ to train the discriminator function to discriminate between the wavefunction ψ of the state generated by the first quantum circuit and the wavefunction ψₙ₋₁ representing each of the n valid states of the system, comprises:

the quantum computer configured to:

generate an nth valid energy state of the system represented by the wavefunction, ψₙ₋₁ by applying, to a set of qubits in an initial state, the first quantum circuit defined by the generator function with the set of parameters having values θₙ₋₁;

determine an output β_{V} to the second quantum circuit by applying, to the set of qubits in the state generated by the first quantum circuit defined by the generator function with the set of parameters having values θₙ₋₁ and to an ancilla qubit, the second quantum circuit, and then measuring the ancilla qubit, wherein the second quantum circuit is defined by the discriminator function with the set of parameters ϕ having a set of trial values ϕ_{T}, and

the classical computer configured to:

compare the output β_{V} of the second quantum circuit to a predefined similarity threshold, Tₛ;

wherein if the output β_{V} of the second quantum circuit is not within a predefined interval of values representing the predefined similarity threshold, Tₛ;

then vary the set of trial values ϕ_{T} and repeating the generating, determining and comparing steps.

Here, the value of the set of parameters ϕ is being optimised to train the discriminator function to properly discriminate between a known, valid energy state and another, very different or ‘opposite’ energy state. To train the discriminator function, the value of the set of parameters ϕ are optimised to yield a value as close as possible to a criterion value when a known, valid state is compared with itself via the discriminator. In other words, where a known state is compared with itself, the discriminator should ideally output a value equal to the criterion value, which is representative of the states being entirely overlapping (in other words, not orthogonal, and not distinguishable). In practice, the criterion is an interval of values representative of the similarity threshold, Tₛ. The specific values for the predefined similarity threshold, Tₛ, will be dependent on the mapping of the difference states within the discriminator costs function, and the weighting of the known and trial states (please see the ‘Mathematical Annex’, below). In some cases, the values for the predefined similarity threshold, T_{d}, will be between zero and 0.001, for instance.

To train the discriminator in this way, the discriminator can be applied to a generated, known and valid state of the system (such as the ground state). The output can then be compared to a set of values being a predefined threshold, the similarity threshold, Tₛ. This indicates whether the set of values of parameters ϕ provide an output from the discriminator which is correct. The similarity threshold, T_{d}, can be an interval of values between 0 and 0.001, although different thresholds could be defined by the user depending on the level of certainty required.

Preferably, the quantum computer configured to measure the ancilla qubit to determine the output β_{V} to the second quantum circuit comprises the quantum computer configured to determine an expectation value of a positive-operator valued measurement of the state of the set of qubits and the ancilla qubit after application of the second quantum circuit.

Preferably, prior to the second quantum circuit being applied, the quantum computer is configured to prepare the ancilla qubit in a pre-defined initial state, |0 [symbol] .

Preferably, the classical computer configured to vary the parameters ϕ_{T} comprises the classical computer configured to vary the parameters ϕ_{T} based on the output of a cost function parameterised by the output to the second quantum circuit, β_{V}. Preferably, the parameters ϕ_{T} are adjusted by minimisation of the output to the cost function. Optionally, the output may be minimised using a gradient method or a gradient-free method such as the RotoSolver algorithm.

Preferably, the classical computer is configured to generate an initial set of randomised parameters, θ_{T} and an initial set of randomised parameters, ϕ_{T}. Alternatively, the initial set of parameters, θ_{T} may be a set of values of parameters, θ, for a known, valid state (such as a ground state or lower excited state. Use of the values of parameters, θ, for a known and valid state may increase the speed of optimisation of the values of parameters, θ, for the n+1th valid energy state of the system. Similarly, initial set of parameters, ϕ_{T} may be set as the final set of parameters, ϕ, during identification of a lower excited state. This may improve the rate of convergence of values for parameters, ϕ_{T}.

In a third aspect, there is described a method for identifying an excited energy state of a system of interacting electrons on a hybrid classical and quantum computer processing unit, comprising:

optimisation of a cooperating generator and discriminator function to generate a set of parameters for the generator function representing an excited energy state of the system which has minimum energy and which also has minimum overlap with a predefined ground energy state.

In other words, known a machine learning technique, such as a generative adversarial network, has been adapted (inverted) to use a generator and discriminator function in cooperation, in order to be used within a quantum system to provide a description of a valid energy state of the system which is both at a local energy minima and which is as different as possible (orthogonal to) a known valid energy sate (such as a known ground state).

### BRIEF DESCRIPTION OF THE DRAWINGS

The disclosure may be put into practice in a number of ways and preferred embodiments will now be described by way of example only and with reference to the accompanying drawings, in which:

FIG. 1A is a schematic diagram of a computing apparatus configured to implement the method for identifying an excited state of a system of interacting electrons;

FIG. 1B is a schematic diagram of a system of qubits to which a first and a second quantum circuit can be applied;

FIG. 2 is a flow chart showing steps of a method for identifying a first excited state of a system of interacting electrons;

FIG. 3A is a flow chart showing the steps of the method at BLOCK A of FIG. 2;

FIG. 3B is a flow chart showing the steps of the method at BLOCK B of FIG. 2;

FIG. 3C is a flow chart showing the steps of the method at BLOCK C of FIG. 2;

FIG. 4 is a flow chart showing steps of a method for identifying an nth excited state of a system of interacting electrons;

FIG. 5A is a flow chart showing the steps of the method at BLOCK A of FIG. 4;

FIG. 5B is a flow chart showing the steps of the method at BLOCK B of FIG. 4; and

FIG. 5C is a flow chart showing the steps of the method at BLOCK C of FIG. 4.

In the drawings, like parts are denoted by like reference numerals. The drawings are not drawn to scale.

### DETAILED DESCRIPTION OF PREFERRED EMBODIMENTS OF THE INVENTION

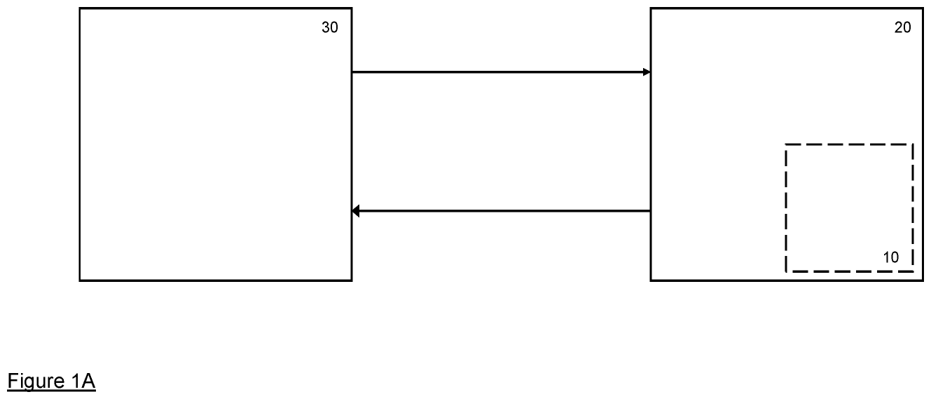

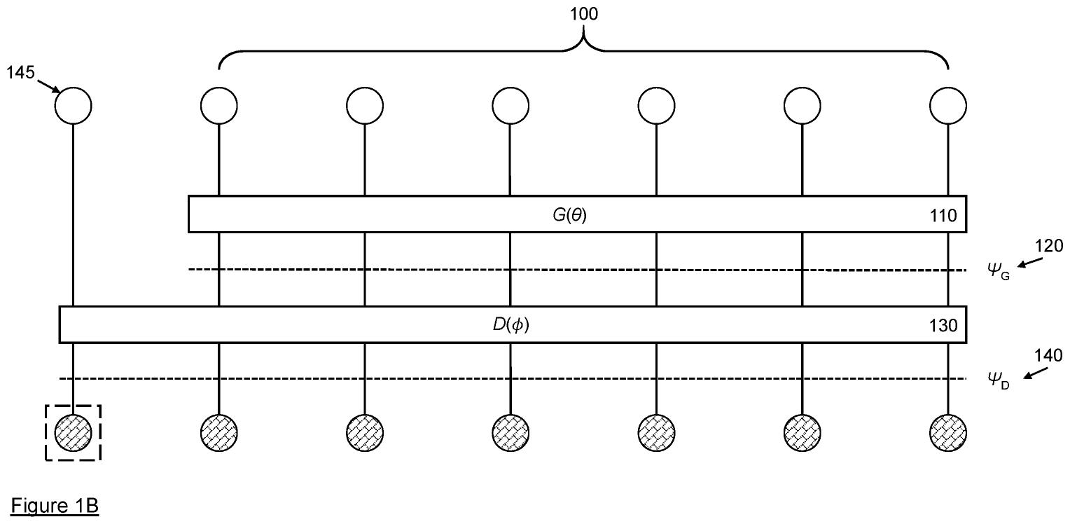

The method described herein may be implemented on a hybrid computing apparatus. In particular, as depicted in FIG. 1A, the hybrid computing apparatus may include a classical computer processor 30, which for example may be a central processing unit, CPU, a graphical processing unit, GPU, or Field-Programmable Gate Array, FPGA. The classical computer processor may perform calculations and transmit and receive data from a quantum computer processor 20. The quantum computer processor 20 comprises a set of qubits 10, one or more of which may be used as an ancilla qubit in certain operations. In particular, a series of quantum circuits can be applied to the set of qubits, as described below. The classical and quantum computer processors may operate cooperatively to perform the method described in the present disclosure.

With reference to FIG. 1B, there is considered an example of the application of quantum circuits (otherwise known as quantum networks) to qubits 10 within a quantum computer 20 (or a quantum computing processor). In particular, there is considered application of a first quantum network, the generator, and a second quantum network, the discriminator, as forming part of the method described in the present disclosure.

Initially, a set of qubits 100 are prepared in a predefined state. In FIG. 1 B, six qubits shown, but any number of qubits could be used. A system of dqubits is described as a set of qubits with dimension d.

A first quantum circuit 110 is applied to the set of qubits 100. The first quantum circuit 110 is defined by the generator (or generator function), G(θ), and parametrised by parameters θ. The first quantum circuit 110, as defined by the generator, G(θ), can be considered to apply a series of parametrised and entangling quantum gates to the set of qubits. As such the qubits are output in a different quantum state 120 (known as a generated state, ψ_{G}). For instance, the values θ₀ for the parameters for the ground state of the system can be applied within the first quantum circuit 110 defined as G(θ₀) in order to reproduce the lowest eigenvector ψ₀ of a Hermitian matrix (the generated ground state). In another example, trial values θ_{T} for the parameters of a trial energy state of the system, can be applied within the first quantum circuit 110 defined as G(θ_{T}) in order to result in a generated trial state ψ_{T} for the set of qubits, which can then be measured.

Referring to FIG. 1B, a second quantum network 130 is applied to the set of qubits in the generated state ψ_{G}, 120, from which they were output from the first quantum network 110. The second quantum network 130 is applied both to the set of qubits 100 and to another qubit 145 (the ancilla qubit) which has been initialized in a known, predefined input state. The role of an ancilla qubit will be known to the skilled person.

The second quantum circuit 130 is defined by the discriminator D(ϕ) parametrized by parameters ϕ. The discriminator D(ϕ) can be considered to apply a series of parametrized and entangling quantum gates to the set of qubits 100 and the ancilla qubit 145. After application of the discriminator D(ϕ), the set of qubits 100 and the ancilla qubit 145 are output in a different quantum state, ψ_{D}.

Subsequent measurement of the ancilla qubit 145 in its state at the output from the discriminator D(ϕ) can yield information on the change to the set of qubits 100 as a result of the discriminator D(ϕ). This is because the ancilla qubit 145 was in a known state prior to the application of the discriminator D(ϕ), and, as the ancilla qubit 145 will be entangled with the set of qubits 100 after application of the Discriminator D(ϕ), any change measured to the state of the ancilla qubit 145 will reflect a change in the state of the set of qubits 100.

The ancilla qubit 145 may be measured using a Positive Operator Value Measurement (POVM), and then obtaining the expectation value. The positive operator value measurement is a known measurement for returning a value of 0 or 1 with probabilities determined by quantum mechanical calculations.

To identify a first excited state of a system of interacting electrons, the method described herein begins with knowledge of a Hermitian matrix encoded on a series of qubits. For instance, this may be the Hamiltonian of the system (which may be a molecule) obtained from the Jordan-Wigner transformation (or any other transformation, such as Parity, Bravyi, Kitaev, etc.). Using this Hamiltonian, the lowest eigenvalue and lowest eigenvector of the matrix can be calculated using a variational quantum eigensolver (VQE). Through VQE, a series of parametrized quantum gates which permit reconstruction of the lowest eigenvector (or at least a sufficient approximation), can also be learned. In this way, a set of values, θ₀, for the parameters of a generator (defining a series of operations of quantum gates) can be obtained for the ground state of the system (represented by the lowest eigenvalue). More specifically, the method obtains the Hamiltonian of the system as a weighted sum of Pauli operators (through one of the transformations mentioned below) which can be measured directly with respect to a parametrised wave-function (which is the output of a quantum circuit). Each Pauli operator needs to be measured independently and then the expectation value of the Hamiltonian can be reconstructed by summing the weighted expectation value of each Pauli operator.

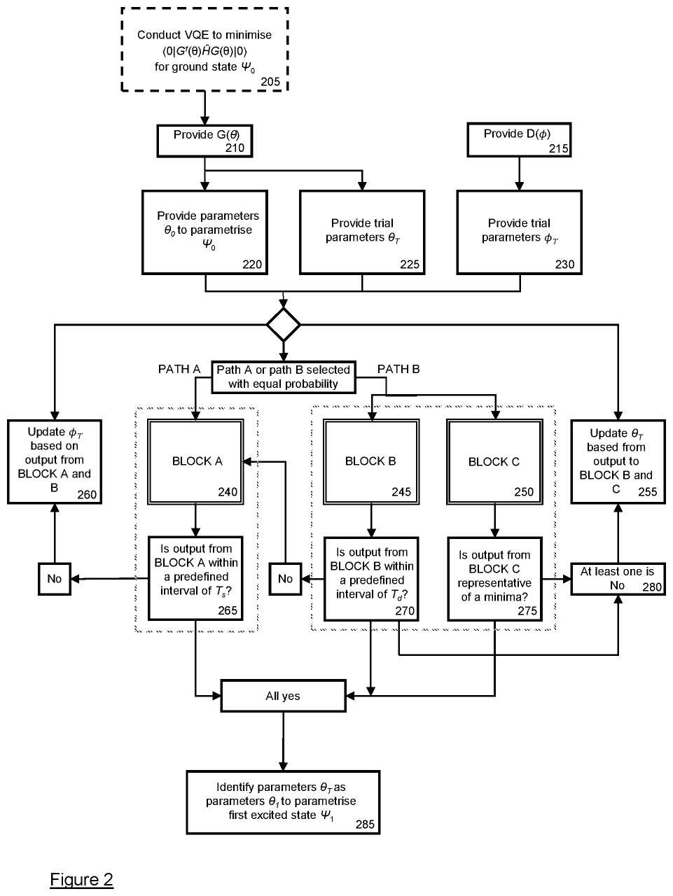

FIG. 2 depicts a flow diagram showing an overview of a method for identifying a first excited state of a system of interacting electrons. In particular, the method illustrated in FIG. 2 may yield a set of parameters representing the second lowest eigenvector ψ₁ (the first excited state) and the second lowest eignenvalue E₁ (the energy of the first excited state). The method may proceed according to the following steps:

Step 205: As an optional step, calculating the ground state eigenvalue and ground state eigenvector of the system of interacting electrons using a variational quantum eigensolver (VQE).
Step 210: Providing or preparing a first parametrised quantum circuit, which will be denoted Generator G(θ).
Step 215: Providing or preparing a second parametrised quantum circuit, which will be denoted Discriminator D(ϕ).
Step 220: Providing a set of values θ₀ for parameters θ, which parametrise G(θ) so that when G(θ) is applied to a set of qubits the ground state, ψ₀ of the system is reproduced. The values θ₀ for parameters θ may have been obtained via the application of the variational quantum eigensolver at step 205. Alternatively, a set of values θ₀ to parametrise the ground state of the system may be obtained by or received from other means.
Step 225: Providing a set of values θ_{T} for parameters θ, which parametrise G(θ) so that when G(θ) is applied to a set of qubits a trial state ψ_{T} is produced. In some cases, the set of values θ_{T} for parameters θ will initially be set to be equal to set of values θ₀. This has been found to improve the efficiency of the method to find an excited state (in other words to provide a ‘warm start’). However, in other case the values θ_{T} for parameters θ will be a randomised set of values.
Step 230: Providing a set of values θ_{T} for parameters θ, to be used within D(ϕ). The values ϕ_{T} for parameters θ may be a randomised set of values.

A loop may then be repeated until convergence, wherein the loop aims to optimize G(θ) and train D(ϕ) in order to provide a set of values θ representative of the first excited state. More specifically, G(θ) is optimized until a set of values θ are identified which represent a generated trial state ψ_{T} that is both minimized in energy and substantially orthogonal to the ground state ψ₀. D(ϕ) is trained to discriminate between a generated trial state ψ_{T} that is orthogonal to the ground state ψ₀, and the ground state ψ₀ itself.

To optimise G(θ) and train D(ϕ) the loop is repeated or iterated. For each iteration of the loop, either a path A or a path B can be followed. The selection of path A or path B is at random, although across all iterations of the loop, path A and path B will each be chosen in approximately 50% of iterations. A large number of iterations may be performed, which will be at least partial dependent on the number of parameters to be estimated.

In an example, for the algorithm to convergence and estimate the value of each parameter may require only 6 full iterations of the method (including 2 iterations of the generator and 3 iterations of the discriminator) using RotoSolver. Therefore, using the simplest possible Hamiltonian (H₂ on two qubits) and using RotoSolver, the number of iterations will be in the range of 6 and 12. However, for a system with twice the complexity, then double or triple the number of iterations may be needed, and even more complex systems will increase the number of iterations significantly. Moreover, it should be noted that the number of iterations needed for the algorithm to converge will be less than the number of iterations required to demonstrate the convergence.

Block A (step 240, below), Block B (step 245, below) and Block C (step 250, below) shown in FIG. 2 may be performed on a quantum computer. Other steps described may be performed on a classical computer. Inputs such as values for parameters θ and parameters ϕ may be passed from the classical computer to the quantum computer. Outputs to the generator G(θ) and discriminator D(ϕ) may be passed from the quantum computer to the classical computer.

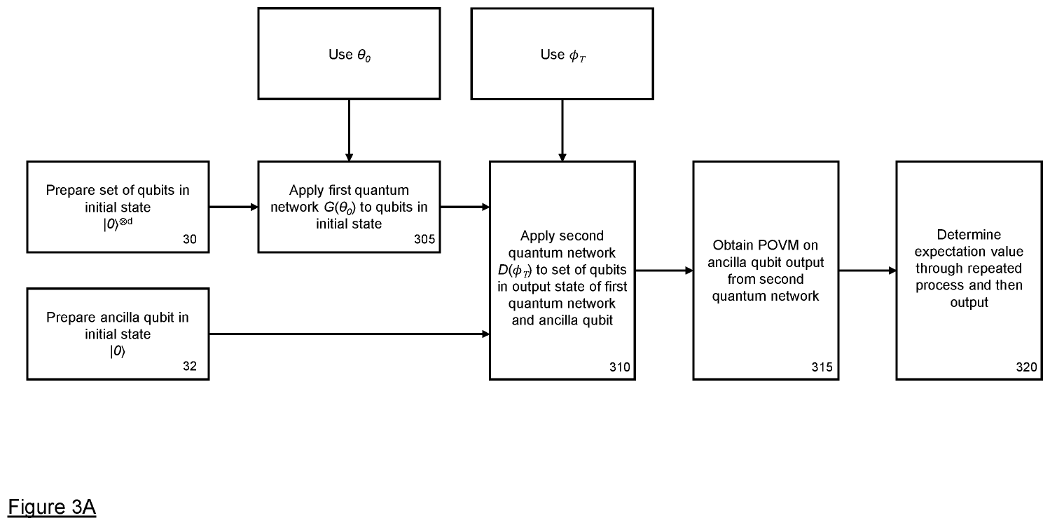

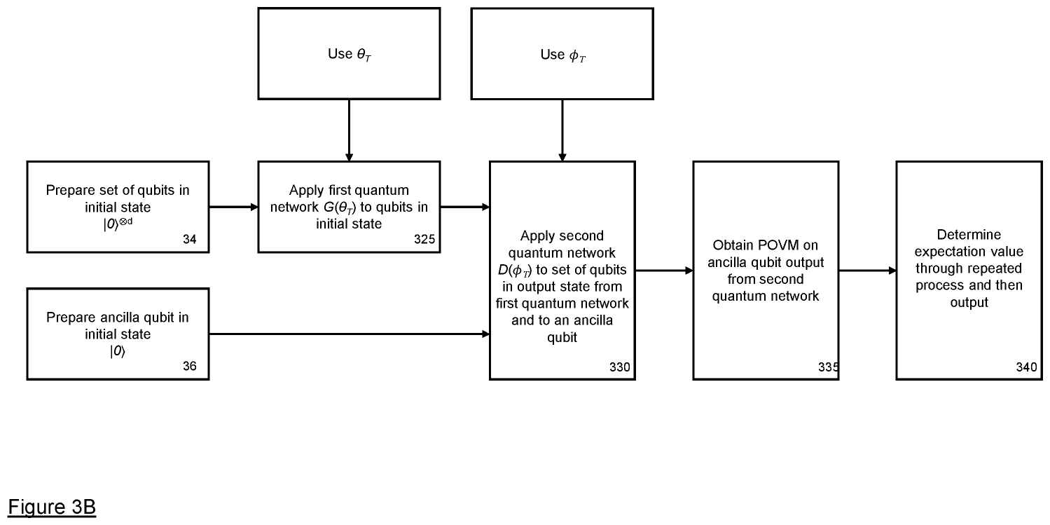

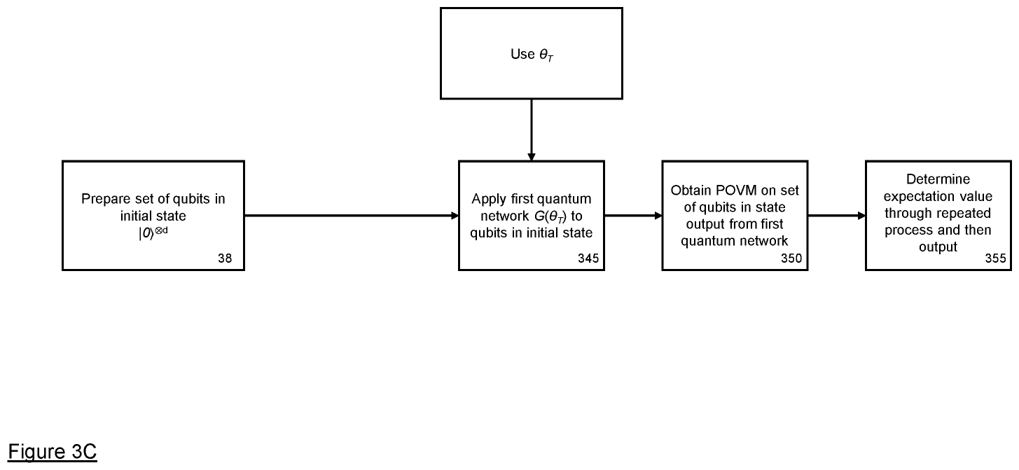

Path A comprises:
Step 240: Applying the discriminator D(ϕ_{T}) to a generated ground state ψ₀ (obtained using G(θ₀)), and obtaining an output to the discriminator D(ϕ_{T}). This step is shown in more detail at FIG. 3A. In particular, the output to the discriminator D(ϕ_{T}) applied to a generated ground state ψ₀ is obtained by steps 305 to 315 below, which are repeated until the measurement expectation value is estimated to the desired level of confidence (wherein, in general, for a precision of ϵ, one needs to conduct c(1/ϵ²) measurements:

Step 305: Preparing the generated ground state ψ₀ (the lowest eigenvector) by application of G(θ) using set of parameters θ with values θ₀ to a set of qbits in a predefined initial state;

Step 310: Applying the discriminator D(ϕ) using set of parameters ϕ with values ϕ_{T} to both the set of qubits in the state ψ₀ output from the generator, and to an ancilla qubit; and

Step 315: Measuring the ancilla qubit to obtain the positive-operator valued measurement (POVM) of the qubits after application of the Discriminator D(ϕ_{T}).

Step 320: Computing the expectation value of the resultant state from the positive-operator valued measurement (POVM).

Step 265: Comparing the output of step 240 to a convergence criteria. Specifically, comparing the output to step 240 to a predefined similarity threshold, Tₛ, wherein only if the output to step 240 is within an interval of values representative of the similarity threshold, Tₛ, is the convergence criteria met. The similarity threshold, Tₛ, is a interval of values (for instance, close to, and including, 0) which represents that the discriminator D(ϕ_{T}) has been trained such that the generated ground state ψ₀ is not distinguishable from the input ground state ψ₀, to an extent less than that defined by the predefined threshold.
Path B comprises:
Step 245: Applying the discriminator D(ϕ_{T}) to a generated trial state, ψ_{T} (obtained using G(θ_{T})), and then obtaining an output to the discriminator D(ϕ_{T}). This step is shown in more detail at FIG. 3B. In particular, the output to the discriminator D(ϕ_{T}) applied to a generated trial state ψ_{T} is obtained by steps 320 to 330 below, which are repeated until measurement expectation value is estimated to the desired level of confidence:

Step 325: Preparing the generated trial state ψ_{T} by application of G(θ) using set of parameters θ with values θ_{T} to a set of qubits in a predefined initial state.

Step 330: Applying the discriminator D(ϕ_{T}) using set of parameters ϕ with values ϕ_{T} to both the set of qubits in the state ψ_{T} output from the generator, and to an ancilla qubit; and

Step 335: Measuring the ancilla qubit to obtain the positive-operator valued measurement (POVM) of the qubits after application of the Discriminator D(ϕ_{T}).

Step 540: Computing the expectation value of the resultant state from the positive-operator valued measurement (POVM).

Step 270: Comparing the output of step 245 to a convergence criteria. Specifically, comparing the output of step 245 to a predefined distinctiveness threshold, T_{d}, wherein only if the output of step 245 is within a user defined interval of the distinctiveness threshold, T_{d} is the convergence criteria met. The distinctiveness threshold, T_{d}, is a number which represents that the generated trial state ψ_{T} is distinguishable from the input ground state ψ₀, to an extent greater than that defined by the predefined threshold.
Step 250: Obtaining the energy of the generated trial state, ψ_{T} (obtained using G(θ_{T})). This step is shown in more detail at FIG. 3C. In particular, the energy is obtained by steps 345 to 355, below:

Step 345: Preparing the generated trial state ψ_{T} by application of G(θ) using set of parameters θ with values θ_{T} to a set of qubits in a predefined initial state.

Step 350: Obtaining the positive-operator valued measurement (POVM) of generated trial state ψ_{T}.

Step 555: Computing the expectation value of the Hermitian matrix with respect to the generated trial state ψ_{T}.

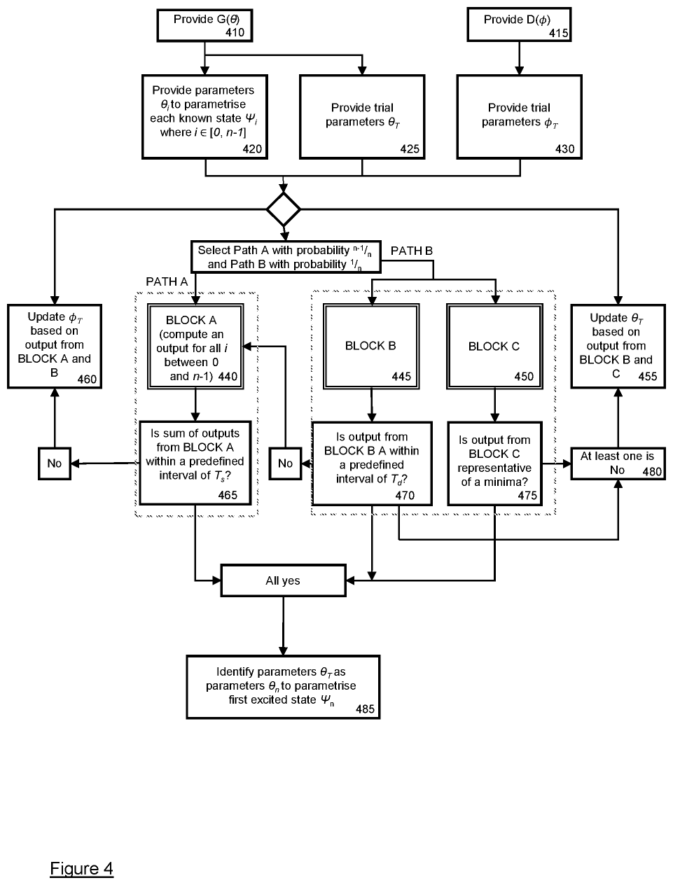

Step 275: Determining if the output to step 250 is representative of a minima. For instance, determining if the energy of the generated trial state ψ_{T} is at least at a local minimum. This can be undertaken using the procedure normally employed in VQE. For instance, starting from an initialised qubit state, the parametrised circuit is applied to generate a state representing the trial state wavefunction ψ_{T}. The expectation value of each Pauli operator is then measured and then each expectation value summed to calculate the expectation value of the Hamiltonian with respect to the wave function. By using either a gradient based method or a gradient free method, the parameters in the quantum circuit can be updated to generate a state representing a new the trial state wavefunction ψ_{T}. The local minimum is identified whenever the expectation value obtained remains substantially the same after several iterations. In practice, the expectation value remaining substantially the same means that the calculated values are within a user-defined interval (in an example, around 0.001 of each other) for at least 2 or 3 iterations (although the requirement could be extended to more iterations).
Step 250 and step 275 may be performed in parallel with step 245 and step 270.
And then, if the convergence criteria at steps 265, 270 and 275 have not been met:
Step 255: Updating the parameters θ_{T} for the generator G(θ) using the preferred optimization method (for instance, gradient free methods such as Rotosolver (see https://arvix.org/abs/1905.09692, accessed 2 Dec. 2019, or gradient methods such as gradient descent, Adam (see https://arvix.org/abs/1412.6980, accessed 2 Dec. 2019), R-prop (see https://en.wikipedia.org/wiki/Rprop, accessed 2 Dec. 2019), etc.). In particular, the parameters θ_{T} may be updated by computing the output to a cost function based on the sum of the outcome of step 245 (multiplied by user defined factor γ) and the outcome of step 250; and/or
Step 260: Updating the parameters ϕ_{T} for the discriminator using the preferred optimization method (for instance, gradient free methods such as Rotosolver, or gradient methods such as Gradient descent, Adam, R-prop, etc.). In particular, the parameters ϕ_{T} may be updated by computing the output to a cost function based on the difference of the outcome of step 245 (multiplied by user defined factor γ) and the outcome of step 240.
The user-defined factor γ mentioned above in Step 255 and Step 260 must be at least the value of the energy gap between the ground energy and the value of the considered energy for the states, multiplied by the number of dimensions of the system studied (the dimension of the system being equal to [symbol] , with d the number of qubits used in the model of the wavefunction).
It is noted that the use of the outcome of step 245 in both the updating of the parameters θ_{T} for the generator and the parameters ϕ_{T} for the discriminator represents the coupled relationship between the generator and discriminator functions.
Once all the convergence criteria at steps 265, 270 and 275 have been met, then the generator G(θ) with parameters having values θ_{T} will have learnt to reproduce the second lowest eigenvector (the first excited state). Thus, the set of trial parameters θ_{T} for which all convergence criteria are met can be identified at the values of parameters θ to generate the first excited state, ψ₁, of the system of interacting electrons, and denoted θ₁ (Step 285).
For more detail, the reader is referred to the “MATHEMATICAL ANNEX”, below.
FIG. 4 provides a flow diagram showing an overview of a method for identifying an n+1th excited state of a system of interacting electrons. In particular, the method illustrated in FIG. 2 may yield the n+1th lowest eigenvector, ψₙ (the nth excited state) and so the n+1th lowest eignenvalue, E (the energy of the nth excited state). In one example, the method of FIG. 4 can be used to find subsequent eigenvectors after obtaining lower energy eignevectors by use of the method of FIG. 2. In this case, the Generator function, G(θ), and Discriminator function, D(ϕ), used in the method of FIG. 2 and FIG. 4 may be the same function (although with different values for parameters θ and parameters ϕ) if applied with respect to the same system of interacting electrons.
The method may proceed according to the following steps:
Step 410: Provide or prepare a first parametrised quantum circuit, which will be denoted

Generator G(θ).

Step 415: Provide or prepare a second parametrised quantum circuit, which will be denoted Discriminator D(ϕ).
Step 420: Provide a set of values θᵢ for parameters θ, which when applied to a set of qubits in G(θ) can reproduce the known, valid state, ψᵢ, where i ∈ [0, n−1]. In other words, n sets of values for parameters θ are known for each of the ground (0^{th}) to n−1^{th} excited state, which represent the n known, valid energy states of the system.
Step 425: Provide a set of values θ_{T} for parameters θ, which when applied to a set of qubits in G(θ) produce a trial state ψ_{T}. In an example, values θ_{T} may initially be set as equal to the values θₙ₋₁ which can be used with the generator function to prepare the highest known eigenvector. Setting values θ_{T} as equal to the values θₙ₋₁ has been found to improve the efficiency of the method to find an excited state (in other words it provides a ‘warm start’). In other case however, the values θ_{T} for parameters θ will be a randomised set of values.
Step 430: Provide a set of values ϕ_{T} for parameters ϕ, to be used within Discriminator D(ϕ). In a preferred example, the set of values ϕ_{T} for parameters ϕ, are the values ϕ_{T} obtained via any previous iteration of the method to identify a lower excited energy state (for example, as discussed above with reference to FIGS. 2 and 3). Alternatively, the values ϕ_{T} for parameters ϕ may be a randomised set of values.

A loop may then be repeated until convergence, wherein the loop results in optimization of the G(θ) and training of D(ϕ) to provide values θ for the n+1th valid energy state (or nth excited state). More specifically, G(θ) is optimized until a set of values θ are identified which represent a generated state ψ_{T} that is both minimized in energy and substantially orthogonal to all known, valid states ψ, where i ∈ [0, n−1]. D(ϕ) is trained to discriminate between a state ψ_{T} that is orthogonal to all known, valid states ψ and a known, valid state ψᵢ itself.

To optimise G(θ) and train D(ϕ) the loop is repeated or iterated. For each iteration of the loop, either path A or path B is followed. A large number of iterations may be performed, as discussed above with respect to FIG. 2. The probability of the selection of path A is n−1/n, and the probability of the selection of path B is 1/n.

Block A (step 440, below), Block B (step 445, below) and Block C (step 450, below) shown in FIG. 4 may be performed on a quantum computer. Other steps described may be performed on a classical computer. Inputs such as values for parameters θ and parameters ϕ may be passed from the classical computer to the quantum computer. Outputs to the generator G(θ) and discriminator D(ϕ) may be passed from the quantum computer to the classical computer.

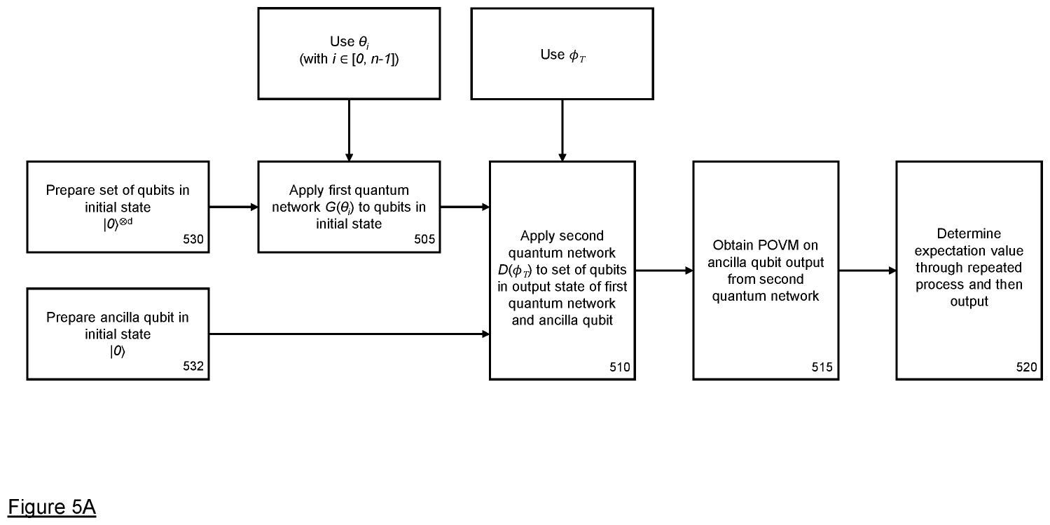

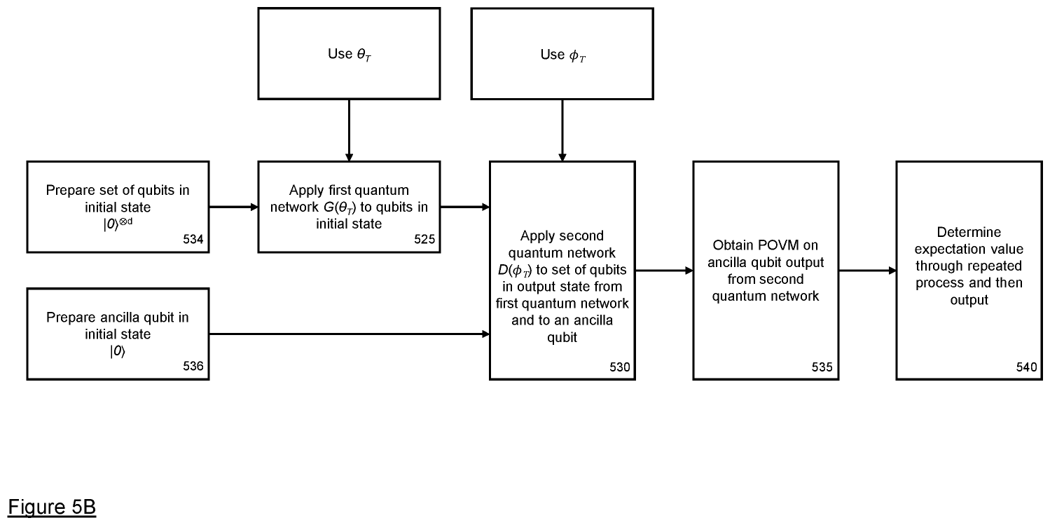

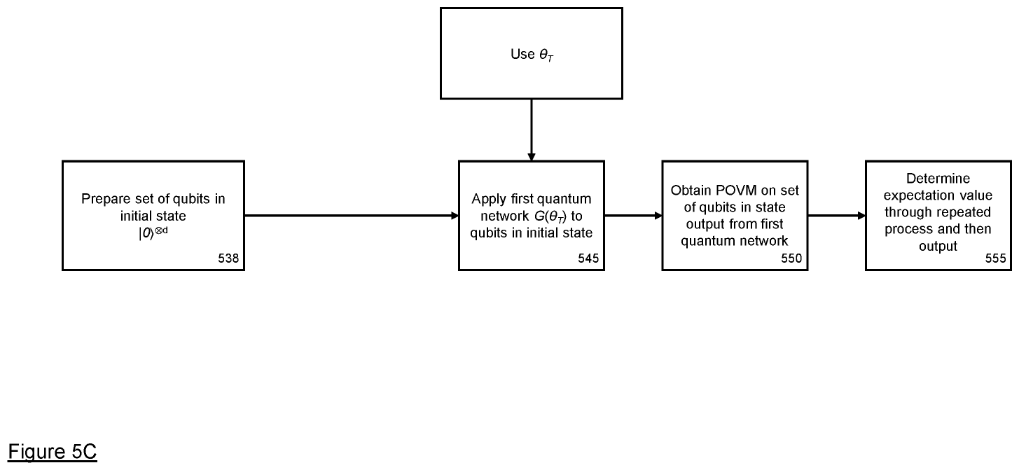

Path A comprises:
Step 440: Applying the discriminator D(ϕ_{T}) to a generated known, valid state ψᵢ (obtained using G(θ₁)), and obtaining an output to the discriminator D(ϕ_{T}). The output is computed for all i between 0 and n−1 and then all outputs summed. The steps to find the output to the discriminator for each generated known, valid state ψᵢ (obtained using G(θ₁)) is shown in more detail at FIG. 5A. In particular, obtaining an output to the discriminator D(ϕ_{T}) applied to a generated known valid state ψ, is obtained by steps 505 to 515 below, which are repeated until the measured expectation value is estimated with sufficient confidence:

Step 505: Preparing the generated known, valid state ψᵢ by application of G(θ) using set of parameters θ with values θᵢ, to a set of qubits in a predefined initial state.

Step 510: Applying the discriminator D(ϕ) using set of parameters ϕ with values ϕ_{T} to both the set of qubits in the state ψ, output from the generator, and to an ancilla qubit; and

Step 515: Measuring the ancilla qubit to obtain the positive-operator valued measurement (POVM) of the qubits after application of the Discriminator D(ϕ_{T}).

Step 520: Computing the expectation value of the resultant state from the positive-operator valued measurement (POVM).

Step 465: Comparing the summed outputs of step 440 to a convergence criteria. Specifically, comparing the sum of the outputs of step 440 to an interval of values representative of a predefined similarity threshold, Tₛ, wherein only if the sum of the outputs of step 440 is within the interval of values representative of the similarity threshold, Tₛ is the convergence criteria met. The similarity threshold, Tₛ, is an interval close to 0 (for instance, 0 to 0.001) which represents that the discriminator D(ϕ_{T}) has been trained such that the generated known, valid state ψᵢ is not distinguishable from the input known, valid state ψᵢ, to an extent less than that defined by the predefined threshold.
Path B comprises:
Step 445: Applying the discriminator D(ϕ_{T}) to a generated trial state, ψ_{T} (obtained using G(θ_{T})), and obtaining an output to the discriminator D(ϕ_{T}). This is shown in more detail at FIG. 5B. In particular, the output to the discriminator D(ϕ_{T}) applied to a generated trial state ψ_{T} is obtained by steps 525 to 540 below, which are repeated until measurement expectation value is estimated to the desired level of confidence:

Step 525: Preparing the generated trial state ψ_{T} by application of G(θ) using set of parameters θ with values θ_{T} to a set of qubits in a predefined initial state.

Step 530: Applying the discriminator D(ϕ_{T}) using set of parameters ϕ with values ϕ_{T} to both the set of qubits in the state ψ_{T} output from the generator, and to an ancilla qubit; and

Step 535: Measuring the ancilla qubit to obtain the positive-operator valued measurement (POVM).

Step 540: Computing the expectation value of the resultant state of the qubits after application of the Discriminator D(ϕ_{T}).

Step 470: Comparing the output of step 445 to a convergence criteria. Specifically, comparing the output of step 445 to a predefined distinctiveness threshold, T_{d}, wherein only if the output of step 445 is within a user defined interval of values representative of the distinctiveness threshold, T_{d} is the convergence criteria met. The distinctiveness threshold, T_{d}, is an interval of values which represent that the generated trial state ψ_{T} is distinguishable from the known, valid state ψᵢ to an extent greater than that defined by the predefined threshold.
Step 450: Obtaining the energy of the generated trial state, ψ_{T} (obtained using G(θ_{T})). This step is shown in more detail at FIG. 5C. In particular, the energy is obtained by steps 545 to 555, below:

Step 545: Preparing the generated trial state ψ_{T} by application of G(θ) using set of parameters θ with values θ_{T} to a set of qubits in a predefined initial state.

Step 550: Obtaining the positive-operator valued measurement (POVM) of generated trial state ψ_{T}

Step 555: Computing the expectation value of the Hermitian matrix considered with respect to the generated trial state ψ_{T}

Step 475: Determining if the output to step 450 is representative of a minima. For instance, determining if the energy of the generated trial state ψ_{T} is at least at a local minimum. This can be undertaken using the procedure normally employed in VQE, as described above with respect to Step 275.
Step 450 and step 475 may be performed in parallel with step 445 and step 470.
And then, if the convergence criteria at steps 465, 470 and 475 have not been met:
Step 255: Updating the parameters ϕ_{T} for the generator G(θ) using the preferred optimization method (for instance, gradient free methods such as Rotosolver, or gradient methods such as Gradient descent, Adam, R-prop, etc.). In particular, the parameters θ_{T} may be updated by computing the output to a cost function based on the sum of the outcome of step 445 and the outcome of step 450; and/or
Step 260: Updating the parameters ϕ_{T} for the discriminator using the preferred optimization method (for instance, gradient free methods such as Rotosolver, or gradient methods such as Gradient descent, Adam, R-prop, etc.). In particular, the parameters ϕ_{T} may be updated by computing the output to a cost function based on the sum of the outcome of step 440 and the outcome of step 445.
The use of the outcome of step 445 in both the updating of the parameters θ_{T} for the generator and the parameters ϕ_{T} for the discriminator represents the coupled relationship between the generator and discriminator functions.
On the other hand, once all the convergence criteria at steps 465, 470 and 475 have been met (after a number of iterations of path A and path B as outlined above), then the generator G(θ) with parameters having values θ_{T} will have learnt to reproduce the n+1^{th} lowest eigenvector. Thus, the set of trial parameters θ_{T} for which all convergence criteria are met can be identified at the values of parameters θ to generate the n+1^{th} valid energy state (n^{th} excited state), ψₙ, of the system of interacting electrons, and denoted θₙ (Step 485).
For more detail, the reader is referred to the “MATHEMATICAL ANNEX”, below.

### EXAMPLE OF INDUSTRIAL APPLICATION

Below, we provide some examples of the application of the present invention within industry.

### Example One—Computing Molecular Energy Structure

A researcher wants to know the energy structure of a complex molecule (e.g. hemoglobin) in order to develop a method to manipulate, synthesize or transform the molecule.

Current classical computational methods only allow for a limited approximation of the molecule's energy structure, but the researcher would like something more precise. The researcher can therefore use the presently described method in order to compute the desired number of excited states (which correspond to the eigenvectors of the Hamiltonian) using a NISQ quantum processor unit paired with a classical processor.

### Example Two—Materials Discovery

A researcher knows the measured spectra produced by a given material, but does not know the actual material studied. With classical computation, the researcher can only list some possible materials and calculate a crude approximation of their spectra, in order to compare with the measured spectra to determine the most likely composition of the measured material.

Using presently described method however, the researcher can perform more precise approximations of the energy spectra, and much faster. Therefore, the researcher can determine with more certainty the composition of the material measured.

### Appendix A—Mathematical Annex

The present annex provides the mathematical definition of the method.
Consider a molecular Hamiltonian, restricted to a d-dimension Hilbert space. It is possible to obtain the ground state energy |s₀ [symbol] using the Variational Quantum Eigensolver (VQE) methodology (as detailed in Peruzzo et al., “A variational eigenvalue solver on a photonic quantum processor”, Nature Communications (2014) vol. 5, 4213), and from here consider the problem of finding higher level excited states |sₙ [symbol] , with n ∈ [0, d].
In order to do so, the elements of the subspace orthogonal to the space spanned by |s₀ [symbol] noted S(|s₀ [symbol] )^{⊥} first need to be found. All excited states lie in this space (∀n, |sₙ [symbol] ∈ S(|s₀ [symbol] )^{⊥}). However, for any system modelled for more than one qubit, S(|s₀ [symbol] )^{⊥} is an infinite vector space, therefore the described method needs to be completed with the additional objective of finding a state in S(|s₀ [symbol] )¹⁹⁵ for which the energy of the system is minimised. |s₁ [symbol] is the element of S(|s₀ [symbol] )^{⊥} for which the Hamiltonian expectation value [symbol] H [symbol] is minimised. Once |s₁ [symbol] is known, an element of S(|s₀ [symbol] )^{⊥}∩S(|s₁₎₎^{⊥}for which [symbol] H [symbol] is minimised is identified, and so on, until the n^{th} excited state is found.
For purpose of clarity the method for finding the first excited state of a molecular Hamiltonian H is initially presented, and then a generalisation to find the nth excited state is described.

### 1. Finding the First Excited State

First the objective of finding a subspace orthogonal to |s₀ [symbol] is addressed, and then how to modify this approach to find |s₁ [symbol] will be considered.
Consider the pure (or ground) state |s₀ [symbol] s₀|, and consider an ansatz ρ_{g} (a generated, trial state) which corresponds to a state initially identical to so and produced through a series of parametrised-rotating and entangling quantum gates applied to an initial state |s₀ [symbol] ^{⊗d}. This quantum network will be named the generator function, and denoted G(θ) (although in the following, θ is omitted where not required for understanding). Thus, ρ_{g}=G(θ)|0 [symbol] [symbol] 0|G⁵⁵⁴ (θ).
Consider also another quantum network, named the discriminator function and labelled D(ϕ), tasked with distinguishing between the original |s₀ [symbol] [symbol] s₀| state and the mimic, produced by the generator. In order to accomplish this task, it is presented with either |s₀ [symbol] [symbol] s₀| or ρ_{g}, randomly but with equal probability.
The discriminator performs a series of rotating-parametrised and entangling quantum gates on the input state (either |s₀ [symbol] [symbol] s₀| or ρ_{g}) followed by a positive-operator valued measurement (POVM). Each possible measurement outcome E_{b}, can occur with a probably P(b)=Tr[E_{b}ρₘᵢₓ], following Born's rule. The discriminator can either be correct, with the POVM results in identifying correctly the input state, or the discriminator can be wrong and POVM results in identifying the incorrect input state. This is similar to the function of the discriminator in the method described in Benedetti et al., New J. Phys. (2019) Vol. 21, 043023.
Accordingly, an objective function for the discriminator POVM is built which minimises the probability of error on a given measurement outcome. Using Bayes decision function, the probably of error can be written as:

$$\begin{matrix}{P}_{err} ( \{ {E}_{b} \} ) = {\sum }_{b} P ( b ) ( 1 - {max}_{x} P ( x \vert b ) ) \\ = {\sum }_{b} P ( b ) {min}_{x} P ( x \vert b ) \\ = {\sum }_{b} {min}_{x} P ( b \vert x ) P ( x ) \\ = {\sum }_{b} {min}_{x} Tr \{ {E}_{b} {ρ}_{x} \} P ( x )\end{matrix} \qquad ( Equation 1 )$$

Therefore, the objective function for the discriminator can be summarised by:

$${P}_{err}^{*} = {min}_{\{ {E}_{b} \}} {P}_{err} ( \{ {E}_{b} \} ) \qquad ( Equation 2 )$$

The outcome of the POVM corresponds to the following: 0 is mapped to the ground state (denoted |s₀ [symbol] ); 1 is mapped to the generated state (denoted |g [symbol] ).
Noting P(g) and P(s₀) the probabilities of the generated state and the ground state being presented to the discriminator, the objective function is given by:

$$\begin{matrix}{P}_{err}^{*} = {min}_{\{ {E}_{0} , {E}_{1} \}} ( P ( 1 \vert {s}_{0} ) P ( {s}_{0} ) + P ( 0 \vert g ) P ( g ) ) \\ = {min}_{\{ {E}_{0} , {E}_{1} \}} ( Tr [ {E}_{1} {ρ}_{{s}_{0}} ] P ( {s}_{0} ) + Tr [ {E}_{0} {ρ}_{g} ] P ( g ) ) \\ = {min}_{\{ {E}_{0} \}} ( Tr [ ( 1 - {E}_{0} ) {ρ}_{{s}_{0}} ] P ( {s}_{0} ) + Tr [ {E}_{0} {ρ}_{g} ] P ( g ) ) \\ = {min}_{\{ {E}_{0} \}} ( - Tr [ ( {E}_{0} ) {ρ}_{{s}_{0}} ] P ( {s}_{0} ) + Tr [ {E}_{0} {ρ}_{g} ] P ( g ) ) + P ( {s}_{0} )\end{matrix} \qquad ( Equation 3 )$$

However this is also dependent on the action of the generator. The objective of the generator is min P*ₑᵣᵣ with respect to ρ_{g}. Incorporating this objective in the equation above the following shared objective function is obtained:

$${min}_{\{ {ρ}_{g} \} } {min}_{\{ {E}_{0} \}} ( - Tr [ {E}_{0} {ρ}_{{s}_{0}} ] P ( {s}_{0} ) + Tr [ {E}_{0} {ρ}_{g} ] P ( g ) ) \\ {min}_{\{ {ρ}_{g} \} } {min}_{\{ {E}_{0} \}} ( Tr [ {E}_{0} {ρ}_{g} ] P ( g ) - Tr [ {E}_{0} {ρ}_{{s}_{0}} ] P ( {s}_{0} ) ) \qquad ( Equation 4 )$$

Where the fixed values have been discarded.
It is possible to set P(g)=P(s₀)=½ and re-write the state as output of the quantum circuit to obtain the value function min_{{θ}} min_{{ϕ}} V(θ, ϕ). With:

V(θ, ϕ)=Tr[E₀D(ϕ)|(G(θ)|0 [symbol] [symbol] 0|G^{†}(θ)⊗|0 [symbol] [symbol] 0|)D^{†}(ϕ)P(g)]−Tr[E₀D(ϕ)(|s₀ [symbol] [symbol] s₀|⊗|0 [symbol] [symbol] 0|)D^{†}(ϕ)P(s₀)] (Equation 5)

The above value function is sufficient for the generator to find at least one state belonging to S(|s₀ [symbol] )^{⊥}. However, it does not guarantee that the state generated is |s₁ [symbol] . In order to do so, a VQE objective can be added to the value function, whereby the generator will also aim to find a state which minimises the expectation value of the Hamiltonian. Re-writing the value function accordingly, the following is obtained:

$$V ( θ , ϕ ) = 〈 0 \vert {G}^{†} ( θ ) HG ( θ ) \vert 0 〉 + Tr [ {E}_{0} D ( ϕ ) ( G ( θ ) \vert 0 〉 〈 0 \vert {G}^{†} ( θ ) ⊗ \vert 0 〉 〈 0 \vert ) {D}^{†} ( ϕ ) P ( g ) ] - Tr [ {E}_{0} D ( ϕ ) ( \vert {s}_{0} 〉 〈 {s}_{0} \vert ⊗ \vert 0 〉 〈 0 \vert ) {D}^{†} ( ϕ ) P ( {s}_{0} ) ] \qquad ( Equation 6 )$$

With this value function, the generated state converges to the first excited state.

### 2. Generalisation to Find the n^{th} Excited State

In order to generalise the method above to find the nth excited state, the outcome of the POVM can be mapped corresponding to the following: 0 is mapped to the ground state |s₀ [symbol] and all i excited states |s₁ [symbol] with i ∈ [0, n−1]; is mapped to the generated state (denoted |g [symbol] ).
The discriminator objective is now given by:

$$\begin{matrix}{P}_{err}^{*} = {min}_{\{ {E}_{0} , {E}_{1} \}} ( P ( 0 \vert g ) P ( g ) + {\sum }_{i} P ( 1 \vert {s}_{i} ) P ( {s}_{i} ) ) \\ = {min}_{\{ {E}_{0} , {E}_{1} \}} ( Tr [ {E}_{0} {ρ}_{g} ] P ( g ) + {\sum }_{i} Tr [ {E}_{1} {ρ}_{{s}_{i}} ] P ( {s}_{i} ) ) \\ = {min}_{\{ {E}_{0} \}} ( Tr [ {E}_{0} {ρ}_{g} ] P ( g ) + {\sum }_{i} Tr [ ( 1 - {E}_{0} ) {ρ}_{{s}_{i}} ] P ( {s}_{i} ) ) \\ = {min}_{\{ {E}_{0} \}} ( Tr [ {E}_{0} {ρ}_{g} ] P ( g ) - {\sum }_{i} Tr [ {E}_{0} {ρ}_{{s}_{i}} ] P ( {s}_{i} ) ) + {\sum }_{i} P ( {s}_{i} )\end{matrix} \qquad ( Equation 7 )$$

However this is also dependent on the action of the generator. The objective of the generator is min P*ₑᵣᵣ with respect to ρ_{g}. Incorporating this objective in the equation above the following shared objective function is obtained:

$${min}_{\{ {ρ}_{g} \} } {min}_{\{ {E}_{0} \}} ( Tr [ {E}_{0} {ρ}_{g} ] P ( g ) - {\sum }_{i} Tr [ {E}_{0} {ρ}_{{s}_{i}} ] P ( {s}_{i} ) ) \qquad ( Equation 8 )$$

Where the fixed values have been discarded.
Transforming the value function and incorporating the VQE objective, it follows that min_{{θ}} min_{{ϕ}}V(θ, ϕ) with:

$$V ( θ , ϕ ) = 〈 0 \vert {G}^{†} ( θ ) HG ( θ ) \vert 0 〉 + Tr [ {E}_{0} D ( ϕ ) ( G ( θ ) \vert 0 〉 〈 0 \vert {G}^{†} ( θ ) ⊗ \vert 0 〉 〈 0 \vert ) {D}^{†} ( ϕ ) P ( g ) ] - {\sum }_{n} Tr [ {E}_{0} D ( ϕ ) ( \vert {s}_{i} 〉 〈 {s}_{i} \vert ⊗ \vert 0 〉 〈 0 \vert ) {D}^{†} ( ϕ ) P ( {s}_{i} ) ] \qquad ( Equation 9 )$$

From the value function:

$$V ( θ , ϕ ) = 〈 0 \vert {G}^{†} HG \vert 0 〉 + γ Tr [ {P}_{0} D ( G \vert 0 〉 〈 0 \vert {G}^{†} ⊗ \vert 0 〉 〈 0 \vert ) {D}^{†} p ( g ) ] - {\sum }_{n} Tr [ {P}_{0} D ( \vert {s}_{i} 〉 〈 {s}_{i} \vert ⊗ \vert 0 〉 〈 0 \vert ) {D}^{†} p ( {s}_{i} ) ] + {\sum }_{i} p ( {s}_{i} ) \qquad ( Equation 10 )$$

The last term is constant and therefore does not impact optimisation. With this value function, the generated states should converge to the n+1 state as long as the optimisation strategy is strong enough. The two following cost functions are obtained, which need to be minimised iteratively for the generator, first, and the discriminator, second:

$$\begin{matrix}{C}_{gen}^{( n )} ( θ ) = 〈 0 \vert {G}^{†} ( θ ) HG ( θ ) \vert 0 〉 + γ Tr [ {P}_{0} D ( ϕ ) ( G ( θ ) \vert 0 〉 〈 0 \vert {G}^{†} ( θ ) ⊗ \vert 0 〉 〈 0 \vert ) {D}^{†} ( ϕ ) p ( g ) ] & ( Equation 11 ) \\ {C}_{disc}^{( n )} ( ϕ ) = γ Tr [ {P}_{0} D ( ϕ ) ( G ( θ ) \vert 0 〉 〈 0 \vert {G}^{†} ( θ ) ⊗ \vert 0 〉 〈 0 \vert ) {D}^{†} ( ϕ ) p ( g ) ] - {\sum }_{n} Tr [ {P}_{0} D ( ϕ ) ( \vert {s}_{i} 〉 〈 {s}_{i} \vert ⊗ \vert 0 〉 〈 0 \vert ) {D}^{†} ( ϕ ) p ( {s}_{i} ) ] & ( Equation 12 )\end{matrix}$$

A weighting factor γ has been added to the generator cost function. This is to guarantee that the minimum of the optimisation problem is indeed the state of index n+1. For this, γ>d(Eₙ₊₁−E₀) must apply. A suitable γ for all states can be found by computing the maximum energy, by running VQE on the inverse Hamiltonian. The weighting factor γ may also be added to the discriminator cost function, although this is not a requirement. More information on the gamma factor γ is provided below
It is worth noting that the generator cost function is identical for any excitation level, while a term is added to the discriminator at each new level of excitation calculated (one for each level of excitation). There is therefore a linear increase in the number of terms to be calculated with number of excited states.

### 3. Gamma Factor γ and Demonstration of Convergence

Consider a generic state |ψ [symbol] =Σᵢ₌₀^{d-1}αᵢ|sᵢ [symbol] such that |ψ [symbol] =G(θ)|0 [symbol] (recalling that d refers to the dimension of the system, and n refers to the last excited state calculated). This state is used in the value function derived in Equation 10, above (discarding θ and ϕ for readability):

$$V = 〈 ψ \vert H \vert ψ 〉 + Tr [ {P}_{0} [ D ( \vert ψ 〉 〈 ψ \vert ⊗ \vert 0 〉 〈 0 \vert ) {D}^{†} ] P ( g ) - γ {\sum }_{i = 0}^{n} Tr [ {P}_{0} [ D ( \vert {s}_{i} 〉 〈 {s}_{i} \vert ⊗ \vert 0 〉 〈 0 \vert ) {D}^{†} ] P ( {s}_{i} ) + {\sum }_{i = 0}^{n} P ( {s}_{i} ) \qquad ( Equation 13 )$$

Given [symbol] sᵢ|H|sᵢ [symbol] =Eᵢ the above equation can be re-written as:

$$\begin{matrix}V = {\sum }_{i = 0}^{d - 1} {\vert {α}_{i} \vert}^{2} {E}_{i} + γ Tr [ {P}_{0} [ D ( {\sum }_{i = 0}^{d - 1} {\vert {α}_{i} \vert}^{2} \vert {s}_{i} 〉 〈 {s}_{i} \vert ⊗ \vert 0 〉 〈 0 \vert ) {D}^{†} ] P ( g ) - {\sum }_{i = 0}^{n} Tr [ {P}_{0} [ D ( \vert {s}_{i} 〉 〈 {s}_{i} \vert ⊗ \vert 0 〉 〈 0 \vert ) {D}^{†} ] P ( {s}_{i} ) + {\sum }_{i = 0}^{n} P ( {s}_{i} ) & ( Equation 14 ) \\ V = {\sum }_{i = 0}^{d - 1} {\vert {α}_{i} \vert}^{2} {E}_{i} + γ {\sum }_{i = 0}^{d - 1} {\vert {α}_{i} \vert}^{2} Tr [ {P}_{0} [ D ( \vert {s}_{i} 〉 〈 {s}_{i} \vert ⊗ \vert 0 〉 〈 0 \vert ) {D}^{†} ] P ( g ) - {\sum }_{i = 0}^{n} Tr [ {P}_{0} [ D ( \vert {s}_{i} 〉 〈 {s}_{i} \vert ⊗ \vert 0 〉 〈 0 \vert ) {D}^{†} ] P ( {s}_{i} ) + {\sum }_{i = 0}^{n} P ( {s}_{i} ) & ( Equation 15 )\end{matrix}$$

To simplify the writing, it is possible to set P(g)=P(sᵢ)=1/d and

$$\begin{matrix} {K}_{i} = \frac{1}{d} Tr [ {P}_{0} [ D ( \vert {s}_{i} 〉 〈 {s}_{i} \vert ⊗ \vert 0 〉 〈 0 \vert ) {D}^{†} ] \text{:} & \\ V = {\sum }_{i = 0}^{d - 1} {\vert {α}_{i} \vert}^{2} ( {E}_{i} + γ {K}_{i} ) - {\sum }_{i = 0}^{n} {K}_{i} + \frac{n}{d} & ( Equation 16 ) \\ V = {\sum }_{i = n + 1}^{d - 1} {\vert {α}_{i} \vert}^{2} ( {E}_{i} + γ {K}_{i} ) + {\sum }_{i = 0}^{n} {\vert {α}_{i} \vert}^{2} ( {E}_{i} + γ {K}_{i} ) - {\sum }_{i = 0}^{n} {K}_{i} + \frac{n}{d} & ( Equation 17 )\end{matrix}$$

At the optimum of the discriminator however, Kᵢ=1/d for i ∈ [0, n]. The remainder of the Kᵢ cannot be determined at this stage. However, once the generator is optimised (conditionally on the discriminator also being at optimum) it follows that Σᵢ₌ₙ₊₁^{d-1}|αᵢ|²Kᵢ=0. The following equation is therefore obtained:

$$V = {\sum }_{i = n + 1}^{d - 1} {\vert {α}_{i} \vert}^{2} ( {E}_{i} ) + {\sum }_{i = 0}^{n} {\vert {α}_{i} \vert}^{2} ( {E}_{i} + \frac{γ}{d} ) \qquad ( Equation 18 )$$

As all the Eᵢ are normally ordered, at an optimal of the VQE objective of the generator function (which in practice optimises the factors αᵢ), only one of the αᵢ is non-null (and therefore equal to 1). Looking at the above equation, it will be the lowest of E₀+1/d and Eₙ₊₁. Therefore, the minimum of the value function is Eₙ₊₁ if γ/d≥Eₙ₊₁−₀.
More specifically, for the state n+1 to be the lowest energy of the value function, it must be that (Eₙ₊₁+γKₙ₊₁) is lower than (Eᵢ+γKᵢ) for any i between 0 and d−1 except n+1. Therefore, together the discriminator and the generator push Kᵢ towards 0 for i greater than n and towards 1 for i lower or equal to n then it is possible for the algorithm to converge to the right state given a large enough γ factor even if the discriminator and generator are not fully optimised. This is a particular advantage for NISQ computers where full optimisation of the discriminator and generator may be impossible due to circuit and read-out errors creating an optimisation barrier.
It is worth noting that the term n/d at the end of the value function has no impact on the optimisation (as it has a null gradient in all parameters of the function). It is valid to discard it and find the same optimal point. The value function at the optimal point would be different but it is still possible to find the eigenstate and eigenenergy.

1. A method for identifying an excited energy state of a system of interacting electrons, comprising:
providing a first quantum circuit, the first quantum circuit defined by a generator function parameterised by a set of parameters, θ, wherein applying the first quantum circuit to a set of qubits in an initial state generates a state of the system represented by a wavefunction, Ψ;
providing n sets of values θₙ₋₁ for the set of parameters, θ, wherein each set of values θₙ₋₁ generates an nth valid energy state of the system represented by a wavefunction, Ψₙ₋₁, wherein n is one or more;
providing a second quantum circuit, the second quantum circuit defined by a discriminator function parameterised by a set of parameters, ϕ, wherein applying the second quantum circuit to the set of qubits in the state of the system represented by the wavefunction, provides an output representing an extent of overlap of the wavefunction with the wavefunction Ψₙ₋₁ of each of the n known valid states of the system;
optimising the values of the set of parameters θ to substantially minimise the energy of the state generated by the first quantum circuit represented by the wavefunction Ψ, and to substantially minimise the extent of overlap of the state generated by the first quantum circuit represented by the wavefunction and each of the n known valid states of the system represented by respective wavefunction Ψₙ₋₁; and
cooperatively, training the discriminator function by optimising the value of the set of parameters ϕ to train the discriminator function to discriminate between the wavefunction Ψ of the state generated by the first quantum circuit and the wavefunction Ψₙ₋₁ representing each of the n valid states of the system;
wherein the optimised values of the set of parameters θ correspond to a set of values θₙ parametrising the generator function defining the first quantum circuit for generating an n+1th valid energy state of the system represented by wavefunction, Ψₙ, which is an excited energy state of the system of interacting electrons.

2. The method of claim 1, wherein optimising the value of the set of parameters θ comprises:
generating a trial energy state of the system represented by a wavefunction Ψ_{T} by applying, to the set of qubits in an initial state, the first quantum circuit defined by the generator function with the set of parameters θ having trial values θ_{T};
determining an output β_{T} to the second quantum circuit by applying, to the set of qubits in the state generated by the first quantum circuit defined by the generator function with the set of parameters having trial values θ_{T} and to an ancilla qubit, the second quantum circuit, and then measuring the ancilla qubit, wherein the second quantum circuit is defined by the discriminator function with the set of parameters ϕ having a set of trial values ϕ_{T};
calculating an energy E_{T} of the trial energy state of the system represented by the wavefunction Ψ_{T};
comparing the output β_{T} of the second quantum circuit to a predefined distinctiveness threshold, T_{d};
wherein if the output β_{T} to the second quantum circuit is not within a predefined interval of values representing the distinctiveness threshold, T_{d}; and/or
if the energy E_{T} of the trial energy state of the system represented by the wavefunction Ψ_{T} is not substantially at a minima;
then varying the set of trial values θₜ and repeating the generating, determining, calculating and comparing steps;
or, if the output β_{T} to the second quantum circuit is within the predefined interval of values representing the distinctiveness threshold, T_{d;} and
if the energy E_{T} of the trial energy state of the system represented by the wavefunction Ψ_{T} is substantially at a minima;
then identifying the set of values θ_{T} as the set of values θₙ parametrising the generator function defining the first quantum circuit for generating the n+1th valid energy state of the system represented by wavefunction, Ψₙ, which is the identified excited energy state of the system of interacting electrons.

3. The method of claim 2, wherein the generating, determining and calculating steps take place at a quantum computer, and the comparing, varying and identifying steps take place at a classical computer.

4. The method of claim 2, wherein calculating an energy E_{T} of the trial energy state of the system represented by the wavefunction Ψ_{T} comprises:
determining the positive-operator valued measurement of the wavefunction Ψ_{T} .

5. The method of claim 2, wherein measuring the ancilla qubit to determine the output β_{T} to the second quantum circuit comprises:
determining an expectation value of a positive-operator valued measurement of the state of the set of qubits and the ancilla qubit after application of the second quantum circuit.

6. The method of claim 2, wherein the parameters θ_{T} are varied based on the output of a cost function parameterised by the energy E_{T} of the trial energy state of the system represented by the wavefunction Ψ_{T} and the output β_{T} to the second quantum circuit.

7. The method of claim 1, wherein training the discriminator function by optimising the value of the set of parameters ϕ comprises:
generating an nth valid energy state of the system represented by the wavefunction, Ψₙ₋₁ by applying, to a set of qubits in an initial state, the first quantum circuit defined by the generator function with the set of parameters having values θₙ₋₁;
determining an output β_{V} to the second quantum circuit by applying, to the set of qubits in the state generated by the first quantum circuit defined by the generator function with the set of parameters having values θₙ₋₁ and to an ancilla qubit, the second quantum circuit, and then measuring the ancilla qubit, wherein the second quantum circuit is defined by the discriminator function with the set of parameters ϕ having a set of trial values ϕ_{T};
comparing the output β_{V} of the second quantum circuit to a predefined similarity threshold, Tₛ;
wherein if the output β_{V} of the second quantum circuit is not within a predefined interval of values representing the similarity threshold, Tₛ;
then varying the set of trial values ϕ_{T} and repeating the generating, determining and comparing steps.

8. The method of claim 7, wherein the generating and determining steps take place at a quantum computer, and the comparing and varying steps take place at a classical computer.

9. The method of claim 7, wherein measuring the ancilla qubit to determine the output β_{V} to the second quantum circuit, comprises:
determining an expectation value of a positive-operator valued measurement of the state of the set of qubits and the ancilla qubit after application of the second quantum circuit.

10. The method of claims 7, wherein the parameters ϕ_{T} are varied based on the output of a cost function parameterised by the output to the second quantum circuit, β_{V}.

11. The method of claim 1, wherein, prior to providing n sets of values θₙ₋₁ for the set of parameters θ, the method further comprises applying a variational quantum eigensolver to identify the set of values, θ₀, parametrising the ground energy state of the system which is a first valid energy state of the system and represented by a wavefunction, Ψ₀.

12. A computing apparatus for identifying an excited energy state of a system of interacting electrons, comprising:
a classical computer; and
a quantum computer comprising a set of qubits, the quantum computer configured to apply a first quantum circuit the first quantum circuit defined by a generator function parameterised by a set of parameters, θ, wherein applying the first quantum circuit to a set of qubits in an initial state generates a state of the system represented by a wavefunction, Ψ, and to apply a second quantum circuit defined by a discriminator function parameterised by a set of parameters, ϕ, wherein applying the second quantum circuit to the set of qubits in a state of the system represented by a wavefunction, Ψ provides an output representing an extent of overlap of the wavefunction Ψ with the wavefunction Ψₙ₋₁ of each of the n known valid states of the system, wherein each of the n known valid states of the system are parametrised by a set of values θₙ₋₁ for the set of parameters, θ;
wherein the computing apparatus is configured to optimise the values of the set of parameters θ to substantially minimise the energy of the state generated by the first quantum circuit represented by the wavefunction Ψ, and to substantially minimise the extent of overlap of the state generated by the first quantum circuit represented by the wavefunction Ψ and each of the n known valid states of the system represented by respective wavefunction Ψₙ₋₁; and
cooperatively, to train the discriminator function by optimising the value of the set of parameters ϕ to train the discriminator function to discriminate between the wavefunction of the state generated by the first quantum circuit and the wavefunction Ψₙ₋₁ representing each of the n valid states of the system;
wherein the optimised values of the set of parameters θ correspond to a set of values θₙ parametrising the generator function defining the first quantum circuit for generating an n+1th valid energy state of the system represented by wavefunction, Ψₙ, which is an excited energy state of the system of interacting electrons.

13. The computing apparatus of claim 12, wherein the computing apparatus configured to optimise the values of the set of parameters θ to substantially minimise the energy of the state generated by the first quantum circuit represented by the wavefunction Ψ, and to substantially minimise the extent of overlap of the state generated by the first quantum circuit represented by the wavefunction Ψ and each of the n known valid states of the system represented by respective wavefunction Ψₙ₋₁ comprises:
the quantum computer being configured to:
generate a trial energy state of the system represented by a wavefunction Ψ_{T} by applying, to the set of qubits in an initial state, the first quantum circuit defined by the generator function with the set of parameters θ having trial values θ_{T};
determine an output β_{T} to the second quantum circuit by applying, to the set of qubits in the state generated by the first quantum circuit defined by the generator function with the set of parameters having trial values θ_{T} and to an ancilla qubit, the second quantum circuit, and then measuring the ancilla qubit, wherein the second quantum circuit is defined by the discriminator function with the set of parameters ϕ having a set of trial values ϕ_{T};
calculate an energy E_{T} of the trial energy state of the system represented by the wavefunction Ψ_{T}; and
the classical computer being configured to:
compare the output β_{T} of the second quantum circuit to a predefined distinctiveness threshold, T_{d};
wherein if the output β_{T} to the second quantum circuit is not within a predefined interval of values representing the distinctiveness threshold, T_{d}; and/or
if the energy E_{T} of the trial energy state of the system represented by the wavefunction Ψ_{T} is not substantially at a minima;
then vary the set of trial values θ_{T};
or, if the output β_{T} to the second quantum circuit is within the predefined interval of values representing the distinctiveness threshold, T_{d}; and
if the energy E_{T} of the trial energy state of the system represented by the wavefunction Ψ_{T} is substantially at a minima;
then identify the set of values θ_{T} as the set of values θₙ parametrising the generator function defining the first quantum circuit for generating the n+1th valid energy state of the system represented by wavefunction, Ψₙ, which is the identified excited energy state of the system of interacting electrons.

14. The computing apparatus of claim 13, wherein the quantum computer being configured to calculate an energy E_{T} of the trial energy state of the system represented by the wavefunction Ψ_{T} comprises the classical computer being configured to:
determine the positive-operator valued measurement of the wavefunction Ψ_{T} .

15. The computing apparatus of claim 13, wherein the quantum computer being configured to measure the ancilla qubit to determine the output β_{T} to the second quantum circuit comprises the quantum computer configured to:
determine an expectation value of a positive-operator valued measurement of the state of the set of qubits and the ancilla qubit after application of the second quantum circuit.

16. The computing apparatus of claim 13, wherein the classical computer being configured to vary the set of trial values θ_{T} comprises the classical computer configured to vary the parameters θ_{T} based on the output of a cost function parameterised by the energy E_{T} of the trial energy state of the system represented by the wavefunction Ψ_{T} and the output β_{T} to the second quantum circuit.

17. The computing apparatus of claim 12, wherein the computing apparatus configured to train the discriminator function by optimising the value of the set of parameters ϕ to train the discriminator function to discriminate between the wavefunction Ψ of the state generated by the first quantum circuit and the wavefunction Ψₙ₋₁ representing each of the n valid states of the system, comprises:
the quantum computer configured to:
generate an nth valid energy state of the system represented by the wavefunction, Ψₙ₋by applying, to a set of qubits in an initial state, the first quantum circuit defined by the generator function with the set of parameters having values θₙ₋₁;
determine an output β_{V} to the second quantum circuit by applying, to the set of qubits in the state generated by the first quantum circuit defined by the generator function with the set of parameters having values θₙ₋₁ and to an ancilla qubit, the second quantum circuit, and then measuring the ancilla qubit, wherein the second quantum circuit is defined by the discriminator function with the set of parameters ϕ having a set of trial values ϕ_{T}; and the classical computer configured to:
compare the output β_{V} of the second quantum circuit to a predefined similarity threshold, Tₛ;
wherein if the output β_{V} of the second quantum circuit is not within a predefined interval of values representing the similarity threshold, Tₛ;
then vary the set of trial values ϕ_{T} and repeating the generating, determining and comparing steps.

18. (canceled)

19. The computing apparatus of claim 17, wherein the classical computer configured to vary the parameters ϕ_{T} comprises the classical computer configured to vary the parameters ϕ_{T} based on the output of a cost function parameterised by the output to the second quantum circuit, β_{V}.

20. The computing apparatus of claims 12, wherein the classical computer is further configured to applying a variational quantum eigensolver to identify the set of values, θ₀, parametrising the ground energy state of the system which is a first valid energy state of the system and represented by a wavefunction, Ψ₀.

21. A method for identifying an excited energy state of a system of interacting electrons on a hybrid classical and quantum computer processing unit, comprising:
optimisation of a cooperating generator and discriminator function to generate a set of parameters for the generator function representing an excited energy state of the system which has minimum energy and which also has minimum overlap with a predefined ground energy state.
